(19) United States
(12) Patent Application Publication
(10) Pub. No.: US 2016/0155151 A1
(43) Pub. Date: Jun. 2, 2016

(54) ADVERTISEMENT SYSTEM, AND ADVERTISEMENT PROCESSING DEVICE

(71) Applicant: RAKUTEN, INC., Tokyo (JP)

(72) Inventors: Udana BANDARA, Setagaya-ku, Tokyo (JP); Alex CHIA, Setagaya-ku, Tokyo (JP); James CHEN, Setagaya-ku, Tokyo (JP)

(21) Appl. No.: 14/901,077

(22) PCT Filed: Jun. 28, 2013
(86) PCT No.: PCT/JP2013/067937

§ 371 Date: Dec. 28, 2015

(51) Int. Cl. G06Q 30/02

(52) U.S. Cl. CPC G06Q 30/0261

(57) ABSTRACT

A position/region setting unit sets, in a case where a request to associate an electronic advertisement with a region in real space is received from a user terminal, a position or a region with which the electronic advertisement is to be associated based on position information that indicates a position of the user terminal and that has been obtained by the user terminal prior to the reception of the request, or based on region information including the position information. An association information registering unit registers, in an association information storage, association information, which indicates an association between the electronic advertisement and the position or the region set by the position/region setting unit.

### TECHNICAL FIELD

The present invention relates to an advertisement system, an advertisement system control method, an advertisement processing device, an advertisement processing device control method, and a program.

### BACKGROUND ART

There have been known systems that provide electronic advertisements. Patent Literature 1, for example, relates to a system that provides electronic coupons, and discloses a technology of transmitting, to a portable terminal, electronic coupons of shops that are located within a given distance from the current position of the portable terminal.

### CITATION LIST

### Patent Literature

[Patent Literature 1] JP 2011-197881 A

### SUMMARY OF INVENTION

### Technical Problem

In real world, an advertisement (e.g., coupons or fliers) is distributed in places farther than a given distance from the location of a shop. For instance, if there is a place that is suitable for advertisement distribution, such as a place where traffic of men is heavy, an advertisement may be distributed in that place even when it is farther than a given distance from a shop's location. As for electronic advertisements (e.g., electronic coupons and electronic fliers), there are cases where providing an electronic advertisement in a place farther than a given distance from the shop's location is desired.

The inventors of the present invention have therefore devised a system in which an electronic advertisement is associated in advance with a real world region designated by a registrant, to provide an electronic advertisement to a user based on the region associated with the electronic advertisement and on the position of the user.

A possible way to attain such a system is employing a configuration that allows a registrant to designate a region on a map displayed on a display unit and that associates the region designated by the registrant with an electronic advertisement.

However, if it is configured that any region on the map can be designated without limitations, a huge number of electronic advertisements may be registered indiscriminatingly. Further, if it is set possible to associate an electronic advertisement with a place without actually visiting and seeing that place, there is also a fear that the electronic advertisement is associated with a place unsuitable for providing an electronic advertisement, such as places where passersby are unlikely to see the advertisement.

The present invention has been made in view of the problem described above, and an object of the present invention is therefore to provide an advertisement system, an advertisement system control method, an advertisement processing device, an advertisement processing device control method, and a program capable of preventing indiscriminate registration of a huge number of electronic advertisements and also preventing associating an electronic advertisement with a place unsuitable as the setting where electronic advertisements are provided.

### Solution to Problem

In order to solve the problem described above, an advertisement system according to the present invention includes: position/region setting means for setting, in a case where a request to associate an electronic advertisement with a region in real space is received from a first user, a position or a region with which the electronic advertisement is to be associated based on position information that has been obtained prior to the reception of the request by first position information obtaining means for obtaining position information about a position of the first user, or based on region information including the position information; association information registering means for registering association information in association information storage means, the association information indicating an association between the electronic advertisement and the position or the region set by the position/region setting means; and electronic advertisement providing means for extracting, in a case where a request to provide an electronic advertisement is received from a second user, an electronic advertisement to be provided to the second user from among electronic advertisements registered in the association information storage means, based on position information that is obtained by second position information obtaining means for obtaining position information about a position of the second user, and on positions or regions that are registered in the association information storage means, and for providing the extracted electronic advertisement to the second user.

Further, an advertisement system control method according to the present invention includes: a position/region setting step of setting, in a case where a request to associate an electronic advertisement with a region in real space is received from a first user, a position or a region with which the electronic advertisement is to be associated based on position information that has been obtained prior to the reception of the request by first position information obtaining means for obtaining position information about a position of the first user, or based on region information including the previously obtained position information; an association information registering step of registering association information in association information storage means, the association information indicating an association between the electronic advertisement and the position or the region set in the position/region setting step; and an electronic advertisement providing step of extracting, in a case where a request to provide an electronic advertisement is received from a second user, an electronic advertisement to be provided to the second user from among electronic advertisements registered in the association information storage means, based on position information that is obtained by second position information obtaining means for obtaining position information about a position of the second user, and on positions or regions that are registered in the association information storage means, and of providing the extracted electronic advertisement to the second user.

Further, an advertisement processing device according to the present invention includes: position/region setting means for setting, in a case where a request to associate an electronic advertisement with a region in real space is received from a user, a position or a region with which the electronic advertisement is to be associated based on position information that has been obtained prior to the reception of the request by position information obtaining means for obtaining position information about a position of the user, or based on region information including the position information; and association information registering means for registering association information in association information storage means, the association information indicating an association between the electronic advertisement and the position or the region set by the position/region setting means.

Further, an advertisement processing device control method according to the present invention includes: a position/region setting step of setting, in a case where a request to associate an electronic advertisement with a region in real space is received from a user, a position or a region with which the electronic advertisement is to be associated based on position information that has been obtained prior to the reception of the request by position information obtaining means for obtaining position information about a position of the user, or based on region information including the position information; and an association information registering step of registering association information in association information storage means, the association information indicating an association between the electronic advertisement and the position or the region set in the position/region setting step.

Further, a program according to one embodiment of the present invention causes a computer to function as: position/region setting means for setting, in a case where a request to associate an electronic advertisement with a region in real space is received from a user, a position or a region with which the electronic advertisement is to be associated based on position information that has been obtained prior to the reception of the request by position information obtaining means for obtaining position information about a position of the user, or based on region information including the position information; and association information registering means for registering association information in association information storage means, the association information indicating an association between the electronic advertisement and the position or the region set by the position/region setting means.

Further, an information recording medium according to the present invention is a computer-readable information recording medium having the above-mentioned program recorded thereon.

Further, in one aspect of the present invention, the position/region setting means may include at least one of: means for setting a position or a region with which the electronic advertisement is to be associated based on a given multiple number of most recent pieces of position information that have been obtained by the first position information obtaining means prior to the reception of the request to associate the electronic advertisement with a region in the real space, or based on region information including at least one of the given multiple number of pieces of position information; and means for setting a position or a region with which the electronic advertisement is to be associated based on a plurality of pieces of position information of a most recent given period that have been obtained by the first position information obtaining means prior to the reception of the request to associate the electronic advertisement with a region in the real space, or based on region information including at least one of the plurality of pieces of position information.

Further, in one aspect of the present invention, the position/region setting means may include: means for identifying a region through which the first user has moved based on position information that has been obtained by the first position information obtaining means prior to the reception of the request to associate the electronic advertisement with a region in the real space, or based on region information including the position information; and means for setting the region through which the first user has moved as a region with which the electronic advertisement is to be associated.

Further, in one aspect of the present invention, the position/region setting means may include: means for identifying a plurality of regions through which the first user has moved based on a plurality of pieces of position information that have been obtained by the first position information obtaining means prior to the reception of the request to associate the electronic advertisement with a region in the real space, or based on region information including at least one of the plurality of pieces of position information; means for presenting the plurality of regions to the first user; means for receiving designation of at least one of the plurality of regions from the first user; and means for setting, as a region with which the electronic advertisement is to be associated, a region that is designated by the first user from among the plurality of regions.

Further, in one aspect of the present invention, the position/region setting means may include means for setting a past position of the first user as a position with which the electronic advertisement is to be associated, based on position information that has been obtained by the first position information obtaining means prior to the reception of the request to associate the electronic advertisement with a region in the real space.

Further, in one aspect of the present invention, the position/region setting means may include: means for presenting to the first user a plurality of past positions of the first user, based on a plurality of pieces of position information that have been obtained by the first position information obtaining means prior to the reception of the request to associate the electronic advertisement with a region in the real space; means for receiving designation of at least one of the plurality of past positions from the first user; and means for setting, as a position with which the electronic advertisement is to be associated, a past position that is designated by the first user from among the plurality of past positions.

Further, in one aspect of the present invention, the advertisement system may further include: estimation means for estimating a current position of the first user, or a region where the first user is currently located, based on position information that has been obtained by the first position information obtaining means prior to the reception of the request to associate the electronic advertisement with a region in the real space, or based on region information including the position information, and the position/region setting means may be configured to set a position or a region with which the electronic advertisement is to be associated, based on the current position of the first user or the region where the first user is currently located that is estimated by the estimation means.

Further, in one aspect of the present invention, the advertisement system may further include: means for determining whether or not a distance between a position of the first user at a first time point and a position of the first user at a second time point is greater than an upper threshold, the first time point being a time point which precedes the reception of the request to associate the electronic advertisement with a region in the real space, and the second time point being a time point which precedes the first time point; and means for inhibiting a registration of the association information in a case where the distance is greater than the upper threshold.

Further, in one aspect of the present invention, the advertisement system may further include: means for determining whether or not a moving speed of the first user is faster than a threshold based on a position of the first user at a first time point and a position of the first user at a second time point, the first time point being a time point which precedes the reception of the request to associate the electronic advertisement with a region in the real space, and the second time point being a time point which precedes the first time point; and means for inhibiting a registration of the association information in a case where the moving speed of the first user is faster than the threshold.

Further, in one aspect of the present invention, the advertisement system may further include: means for determining whether or not a distance between a position of the first user at a first time point and a position of the first user at a second time point is less than a lower threshold, the first time point being a time point which precedes the reception of the request to associate the electronic advertisement with a region in the real space, and the second time point being a time point which precedes the first time point, and the position/region setting means may be configured to set, in a case where the distance is less than the lower threshold, a position or a region with which the electronic advertisement is to be associated based on at least one of the position of the first user at the first time point and the position of the first user at the second time point.

### Advantageous Effects of Invention

According to the embodiments of the present invention, indiscriminate registration of a huge number of electronic advertisements may be prevented and associating an electronic advertisement to a place unsuitable as the setting where electronic advertisements are provided may also be prevented. The embodiments of the present invention also make use of past position information of a user that is obtained before a request to associate an electronic advertisement with a region in the real space is received from the user, thereby eliminating the need to obtain position information after receiving the request and saving time that is required to obtain position information.

### BRIEF DESCRIPTION OF DRAWINGS

FIG. 1 is a diagram for illustrating an example of the overall configuration of an advertisement system according to an embodiment of the present invention.

FIG. 2 is a diagram for illustrating the outline of a function of the advertisement system.

FIG. 3 is a diagram for illustrating the outline of the function of the advertisement system.

FIG. 4 is a diagram for illustrating an example of a menu screen.

FIG. 5 is a diagram for illustrating an example of a coupon list screen.

FIG. 6 is a diagram for illustrating an example of a coupon screen.

FIG. 7 is a diagram for illustrating an example of a section designating screen.

FIG. 8 is a diagram for illustrating a candidate region.

FIG. 9 is a diagram for illustrating another example of the section designating screen.

FIG. 10 is a diagram for illustrating an example of a coupon list screen.

FIG. 11 is a diagram for illustrating an example of a coupon screen.

FIG. 12 is a function block diagram of the advertisement system.

FIG. 13 is a diagram for showing an example of a user table.

FIG. 14 is a diagram for showing an example of a user position table.

FIG. 15 is a diagram for showing an example of an advertiser table.

FIG. 16 is a diagram for showing an example of an electronic coupon table.

FIG. 17 is a diagram for showing an example of a possession status table.

FIG. 18 is a diagram for showing an example of a section table.

FIG. 19 is a diagram for showing an example of a registration status table.

FIG. 20 is a diagram for illustrating an example of processing that is executed in the advertisement system.

FIG. 21 is a diagram for illustrating the example of processing that is executed in the advertisement system.

FIG. 22 is a diagram for illustrating another example of processing that is executed in the advertisement system.

FIG. 23 is a diagram for illustrating still another example of processing that is executed in the advertisement system.

FIG. 24 is a diagram for illustrating another example of the section designating screen.

### DESCRIPTION OF EMBODIMENTS

An embodiment of the present invention is described below in detail with reference to the drawings.

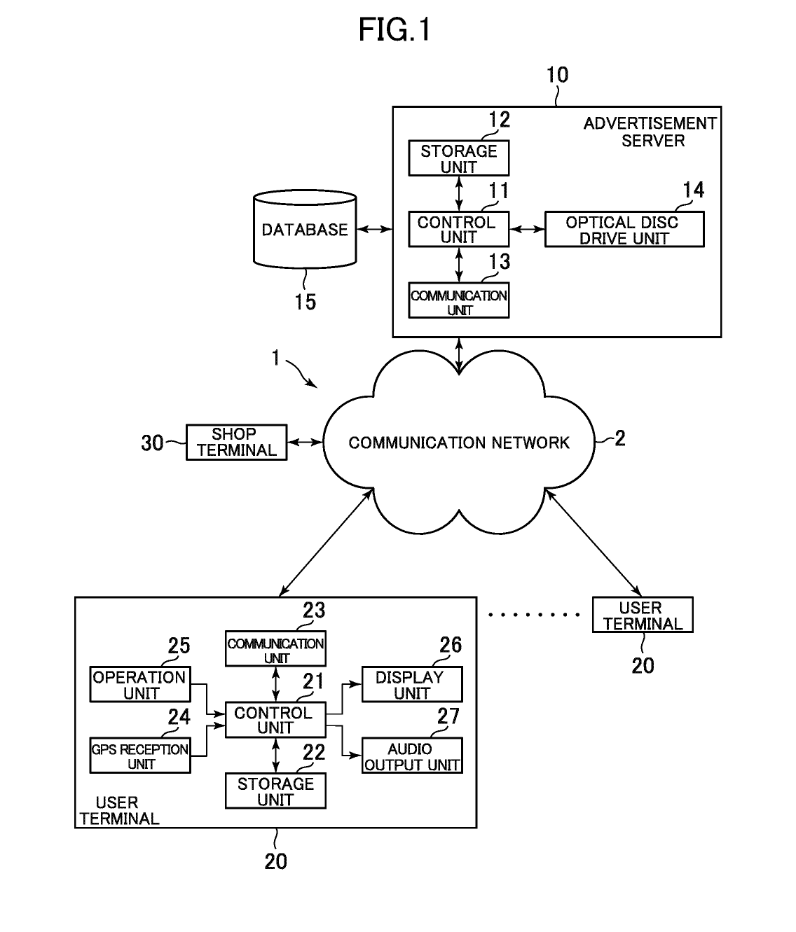

FIG. 1 is a diagram for illustrating an example of the overall configuration of an advertisement system according to the embodiment of the present invention. An advertisement system 1 according to this embodiment includes, as illustrated in FIG. 1, an advertisement server 10 (advertisement processing device), a database 15, a user terminal 20, and a shop terminal 30.

The advertisement server 10, the user terminal 20, and the shop terminal 30 are connected to a communication network 2. Two-way data communication can be executed between the advertisement server 10 and the user terminal 20. Further, the advertisement server 10 and the shop terminal 30 can execute two-way data communication as well between themselves.

The advertisement server 10 is a server configured to provide electronic advertisements. The advertisement server 10 includes a control unit 11, a storage unit 12, a communication unit 13, and an optical disc drive unit 14. The control unit 11 includes, for example, one or more microprocessors and executes processing as instructed by an operating system or a program that is stored in the storage unit 12. The storage unit 12 includes a main memory unit and an auxiliary storage unit. For example, the main memory unit is a RAM and the auxiliary storage unit is a hard disk, solid state drive, or the like.

The communication unit 13 is configured to execute data communication via the communication network 2. The optical disc drive unit 14 reads a program and data stored on an optical disc (information storage medium). Programs and data are supplied to the storage unit 12 via the communication network 2. Alternatively, programs and data are supplied to the storage unit 12 via an optical disc. Specifically, a program or data stored on an optical disc is read by the optical disc drive unit 14 and stored in the storage unit 12.

Note that the advertisement server 10 may include a component configured to read a program or data that is stored in information storage media other than optical discs (for example, memory cards). Then, programs and data may be supplied to the storage unit 12 via information storage media other than optical discs.

The advertisement server 10 is capable of accessing the database 15. The database 15 may be built in the advertisement server 10, or may be built in a server other than the advertisement server 10. Information necessary to provide electronic advertisements is stored in the database 15.

The user terminal 20 is an information processing device used by a user. The user terminal 20 is a portable information processing device that can be carried around by the user, such as a cellular phone (including smartphones), a portable information terminal (including tablet computers), a laptop personal computer, or the like. Note that the user terminal 20 in the following description is assumed to be a cellular phone (smartphone).

The user terminal 20 includes a control unit 21, a storage unit 22, a communication unit 23, a GPS reception unit 24, an operation unit 25, a display unit 26, and an audio output unit 27. The control unit 21 and the storage unit 22 are the same as the control unit 11 and the storage unit 12 of the advertisement server 10, respectively.

The communication unit 23 is configured to execute data communication via the communication network 2. The communication unit 23 has, for example, a data communication function that utilizes a cellular phone communication network, and is capable of executing data communication via cellular phone base stations set up in each place. In another example, the data communication unit 23 has a data communication function that is in conformity to wireless LAN standards, and is capable of executing data communication via wireless LAN base stations (access points) set up in each place.

The GPS reception unit 24 receives signals transmitted from a plurality of GPS satellites. An operating system of the user terminal 20 obtains position information (the latitude and longitude) of the user terminal 20 based on the signals received by the GPS reception unit 24.

Note that the operating system of the user terminal 20 may obtain the position information of the user terminal 20 based on position information of a cellular phone base station that is communicating with the user terminal 20. Alternatively, the operating system of the user terminal 20 may obtain the position information of the user terminal 20 based on position information of a wireless LAN base station that is communicating with the user terminal 20.

The operating system of the user terminal 20 obtains the position information of the user terminal 20 at a given time interval. Further, the position information can be utilized by an application program that is run on the user terminal 20.

The operation unit 25 is for a user to operate. In the case where the user terminal 20 is a cellular phone or a portable information terminal, for example, buttons (keys), a stick, a touch panel, or the like that is provided on the cellular phone or the portable information terminal corresponds to the operation unit 25. Further, in the case where the user terminal 20 is a personal computer, keys, a stick, a touch pad, a mouse, or the like that is provided on the personal computer corresponds to the operation unit 25.

In the following description, it is assumed that the user terminal 20 has a touch panel overlaid on the display unit 26 and that the user operates the user terminal 20 with the use of the touch panel. Specifically, the description is given with the assumption that the user selects (designates) an object displayed on the display unit 26 by touching the touch panel with a finger or a touch pen.

The display unit 26 is, for example, a liquid crystal display panel, an organic EL display panel, or the like, and displays various screens as instructed by the control unit 21. The audio output unit 27 is, for example, a speaker, earphones, headphones, or the like, and outputs various kinds of audio as instructed by the control unit 21.

Note that the program and data are supplied to the storage unit 22 via the communication network 2. The user terminal 20 may include a component configured to read a program or data that is stored in an information storage medium (for example, a memory card slot unit, an optical disc drive unit, or the like). Then, programs and data may be supplied to the storage unit 22 via an information storage medium.

The shop terminal 30 is an information processing device that is used at a shop of an advertiser, and is, for example, a personal computer or the like. As the user terminal 20, the shop terminal 30 includes a control unit, a storage unit, a communication unit, an operation unit, a display unit, and others. Further, the shop terminal 30 has a function of reading a code image that is displayed on the display unit 26 of the user terminal 20 in order to, for example, accept the use of an electronic coupon.

In this embodiment, a daemon (for example, an HTTP daemon) that receives a processing request from the user terminal 20 or the shop terminal 30 is activated on the advertisement server 10. On the user terminal 20 or the shop terminal 30, on the other hand, an application program for accessing the advertisement server 10 is activated and transmits a processing request (for example, an HTTP request) to the advertisement server 10.

Data about the result of processing executed in response to the processing request (for example, an HTTP response) is then transmitted from the advertisement server 10 to the user terminal 20 or the shop terminal 30. For example, page data written in a Web page description language is transmitted to the user terminal 20 or the shop terminal 30. The user terminal 20 or the shop terminal 30 displays, based on the page data, a screen (Web page) that is based on the processing result.

The advertisement system 1 configured as described above provides electronic advertisements to users. Electronic coupons or electronic fliers, for example, are provided to users. In other words, the advertisement system 1 provides coupons or fliers electronically to users, which can further be rephrased as providing coupon data or flier data to users.

The following description takes, as an example, a case of providing electronic coupons to users. A “coupon” is a ticket for receiving a privilege at a shop (real shop). For example, a “coupon” is a discount ticket for getting a discount when purchasing a product, or using a service, at a shop, or a voucher that can be exchanged for an item or a given service at a shop.

For example, whether or not a user has entered a vicinity region of a shop is determined based on the position information of the user terminal 20 and, in the case where the user has entered a vicinity region of the shop, an electronic coupon that can be used at the shop is given to the user. Further, an electronic coupon may be given to a user also when the user purchases a product at a shop or when the user uses a service at a shop, for example. Note that any method can be employed as a method to give a user an electronic coupon directly from a shop.

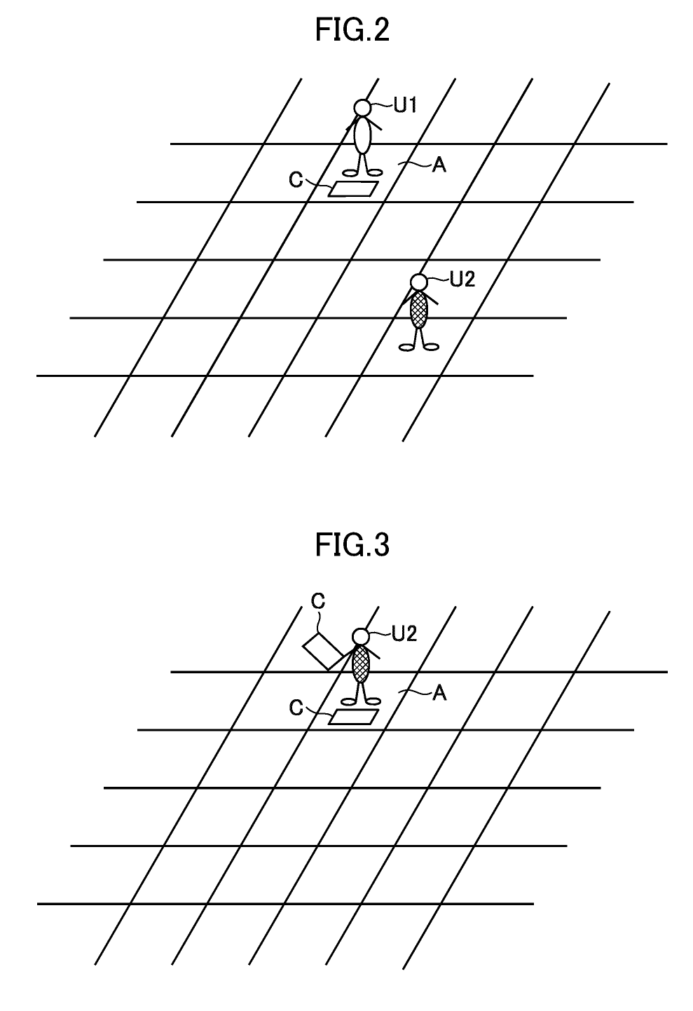

In particular, in the advertisement system 1 according to this embodiment, it is possible to distribute an electronic coupon obtained by a user to another user. FIG. 2 and FIG. 3 are diagrams for illustrating the outline of this function.

The advertisement system 1 according to this embodiment, it is possible to virtually put an electronic coupon that the user possesses in a region in the real space. As illustrated in FIG. 2, a user U1 who possesses an electronic coupon C moves to a region A or the vicinity of the region A, activates an application program on the user terminal 20, and performs given operation, to thereby associate the electronic coupon C with the region A.

Further, by moving to the region to which an electronic coupon is virtually put by another user, a user can obtain that electronic coupon. As illustrated in FIG. 3, a user U2 moves to the region A, which is associated with the electronic coupon C by the user U1, activates an application program on the user terminal 20, and performs given operation, to thereby obtain the electronic coupon C.

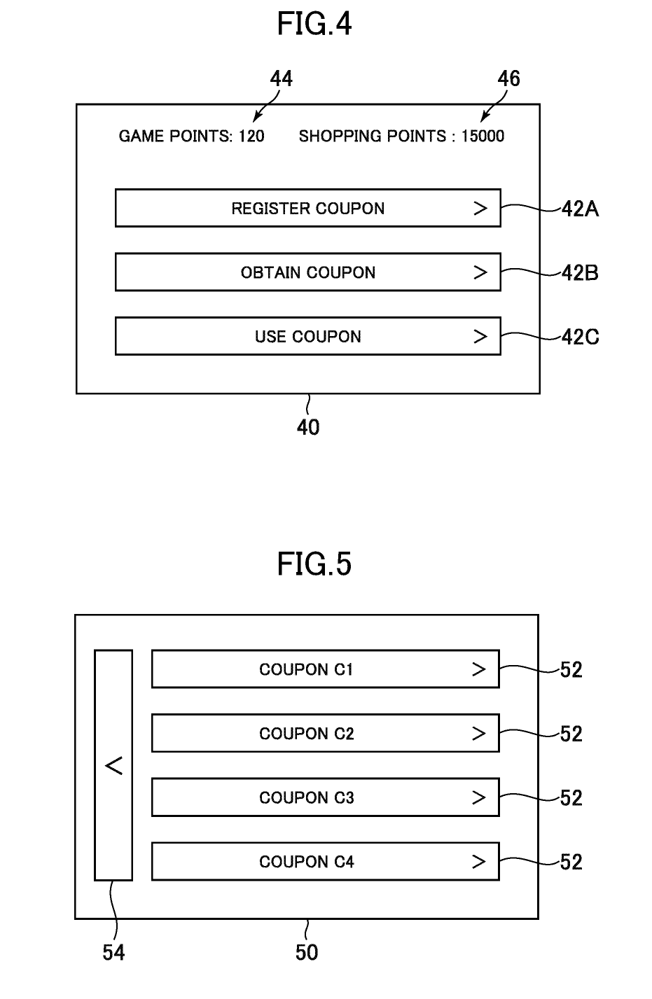

Operation to be performed by a user is described below. FIG. 4 to FIG. 9 are diagrams for illustrating this operation, and FIG. 4 to FIG. 7 and FIG. 9 are each an example of a screen displayed on the display unit 26 of the user terminal 20. These screens are displayed as a result of data communication between the user terminal 20 and the advertisement server 10. Further, the description is given here with an assumption that the user is holding the user terminal 20 so that the display unit 26 looks long horizontally from the viewpoint of the user.

To use a service provided by the advertisement server 10, the user activates on the user terminal 20 an application program for accessing the advertisement server 10. When the application program is activated, a menu screen is displayed after a user authentication is executed.

FIG. 4 is an example of the menu screen. A menu screen 40 of FIG. 4 displays three menu buttons, 42A, 42B, and 42C, a game point field 44, and a shopping point field 46. Note that the game point field 44 indicates the current game points of the user. Further, the shopping point field 46 indicates remaining shopping points that the user has at present. Shopping points can be used at a real shop or a virtual shop. Specifically, the user can redeem shopping points for all or part of the price of a product purchased or a service received. Details of the game points and the shopping points are described later.

A series of operation steps for virtually putting an electronic coupon in a region in the real space is described first. In other words, a series of operation steps for associating an electronic coupon with a region in the real space is described. In the following description, “virtually putting an electronic coupon in a region in the real space” or “associating an electronic coupon with a region in the real space” is expressed as “registering an electronic coupon to a region in the real space”.

The menu button 42A is a button for registering an electronic coupon to a region in the real space. When the menu button 42A is selected, a coupon list screen is displayed.

FIG. 5 is an example of the coupon list screen. This coupon list screen 50 is a screen displaying a list of electronic coupons that the user possesses at present. The coupon list screen 50 of FIG. 5 displays a plurality of coupon buttons 52 and a back button 54. The back button 54 is a button for returning to the menu screen 40.

Each coupon button 52 corresponds to each of electronic coupons that the user possesses. FIG. 5 indicates that the user possesses four electronic coupons, C1, C2, C3, and C4.

The user selects, on the coupon list screen 50, an electronic coupon that he wants to register to a region in the real space (hereinafter referred to as “registration target electronic coupon”). Specifically, the user selects a registration target electronic coupon by selecting one of the coupon buttons 52. When a registration target electronic coupon is selected, a coupon screen is displayed.

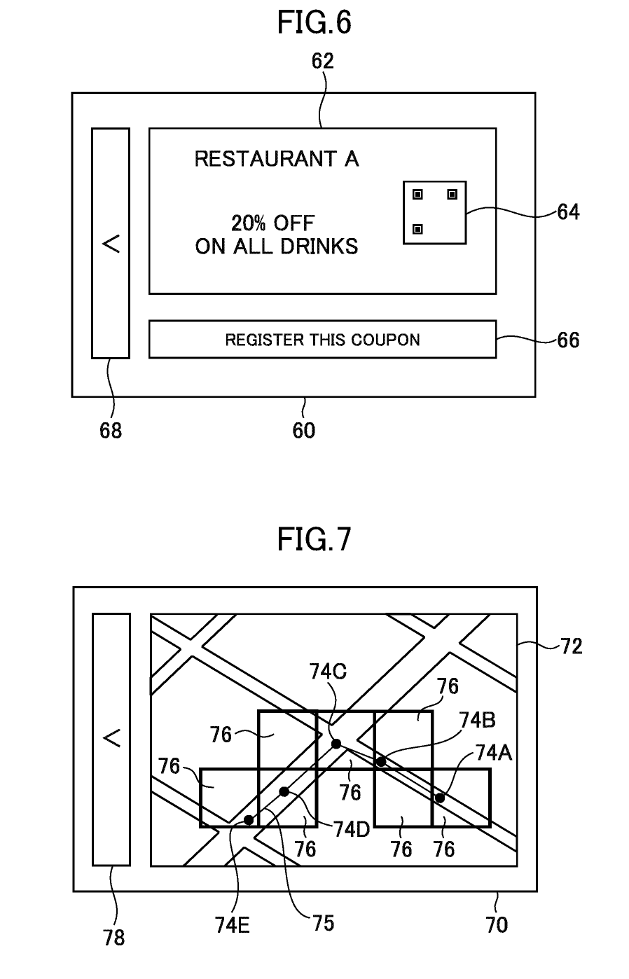

FIG. 6 is an example of the coupon screen. A coupon screen 60 is a screen that displays details of a registration target electronic coupon. The coupon screen 60 of FIG. 6 displays a coupon 62. Specifically, a shop at which the electronic coupon can be used and the specifics of a privilege that is granted by the electronic coupon are displayed. Further, the coupon screen 60 displays a code image 64. The code image 64 is an image in which identification information about an electronic coupon is made into a code.

The coupon screen 60 also displays a registration button 66 and a back button 68. The back button 68 is a button for returning to the coupon list screen 50. The user selects the registration button 66 in the case where the electronic coupon that is displayed on the coupon screen 60 is determined as a registration target electronic coupon. When the registration button 66 is selected, a section designating screen is displayed.

FIG. 7 is an example of the section designating screen. A section designating screen 70 is a screen for designating a region to which an electronic coupon is registered (hereinafter referred to as “registration target region”). The section designating screen 70 of FIG. 7 displays a back button 78. The back button 78 is a button for returning to the coupon screen 60.

The section designating screen 70 of FIG. 7 also displays a map 72 of the surroundings of a plurality of most recent user positions 74A, 74B, 74C, 74D, and 74E. The map 72 is displayed so that, for example, the plurality of most recent user positions 74A, 74B, 74C, 74D, and 74E are all displayed on the map 72. Though omitted in FIG. 7, information such as place names, road names, facility names and the likes are displayed on the map 72, actually.

Further, on the map 72, the section designating screen 70 displays a candidate region 76, which is a candidate for the registration target region.

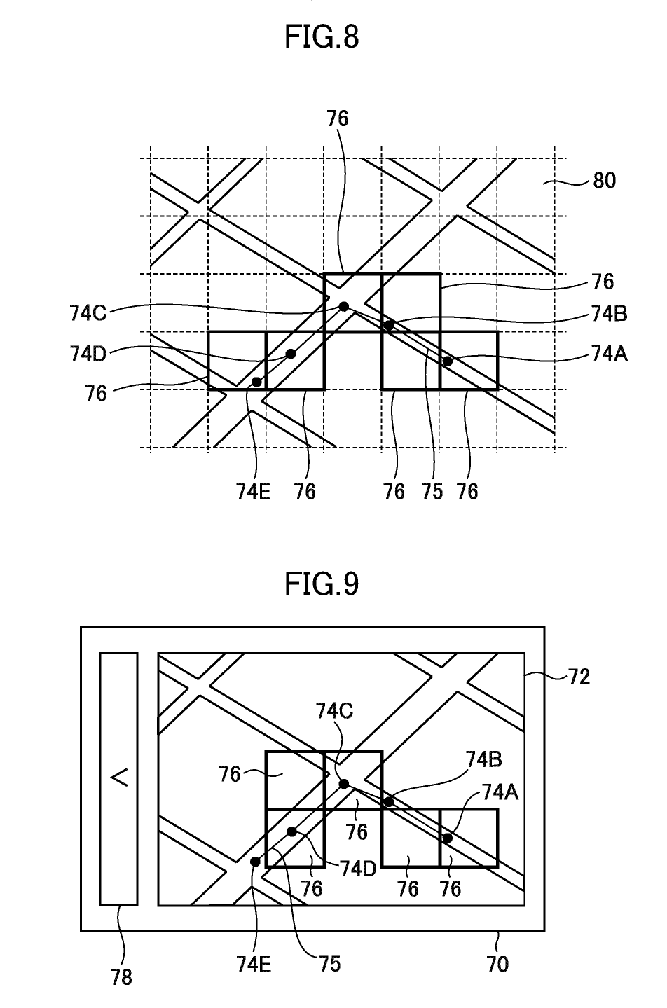

FIG. 8 is a diagram for illustrating the candidate region 76. In the advertisement system 1, the real space (a map) is sectioned into a plurality of rectangular sections 80 in advance as illustrated in FIG. 8. Then, the sections 80 through which the user has moved are set as the candidate region 76. For instance, a plurality of sections 80 that include a line 75 connecting a plurality of the most recent user positions 74A, 74B, 74C, 74D, and 74E in order are set as the candidate region 76.

The user designates, on the section designating screen 70, as a registration target region, one of the plurality of sections 80 set as the candidate region 76. When the user designates one of the plurality of sections 80 as a registration target region, the designated section 80 is associated with the registration target electronic coupon and the registration target electronic coupon is registered to the designated section 80.

Note that a plurality of different electronic coupons can be registered to one section 80, whereas registering a plurality of identical electronic coupons to one section 80 is not permitted. The section 80 through which the user has moved but to which the same electronic coupon as the registration target electronic coupon is already registered is therefore not set as a candidate region 76. Also, such sections 80 are not displayed as a candidate region 76 on the section designating screen 70.

FIG. 9 is an example of how the section designating screen 70 looks in this case. Illustrated in FIG. 9 is a case where the same electronic coupon as the registration target electronic coupon is already registered to the section 80 that includes the user position 74B and the section 80 that includes the user position 74E. Therefore, the section 80 that includes the user position 74B and the section 80 that includes the user position 74E are not displayed as a candidate region 76 on the section designating screen 70 of FIG. 9.

Note that an expiration date is set to the registration of an electronic coupon. For instance, when a given length of time (e.g., 3 hours) elapses since the registration of an electronic coupon by one user to the section 80, another user is allowed to register an identical electronic coupon. The registration of the electronic coupon by the former user remains valid, even after the elapse of the given length of time as above, until another user registers the electronic coupon. When another user registers the electronic coupon, the registration of the electronic coupon by the former user is invalidated.

A series of operation steps for obtaining an electronic coupon that has been registered to a region in the real space is described next. The menu button 42B of FIG. 4 is a button for obtaining an electronic coupon that has been registered to a region in the real space. When the menu button 42B is selected, the coupon list screen is displayed.

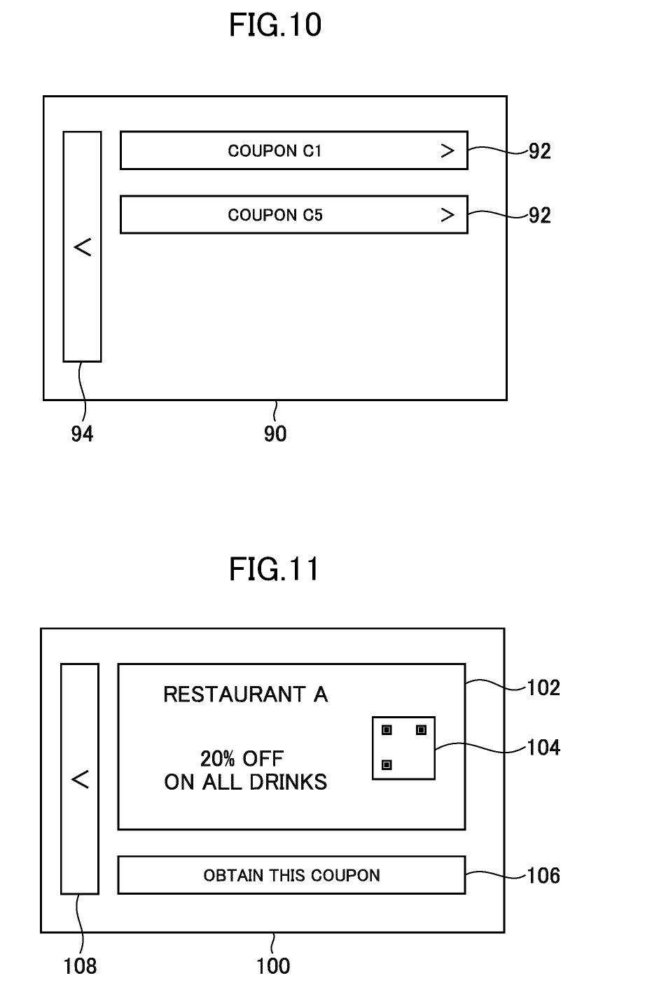

FIG. 10 is an example of a coupon list screen in this case. This coupon list screen 90 is a screen displaying a list of electronic coupons registered to the section 80 where the user is located at present. The coupon list screen 90 of FIG. 10 displays a plurality of coupon buttons 92 and a back button 94. The back button 94 is a button for returning to the menu screen 40.

Each coupon button 92 corresponds to each of electronic coupons registered to the section 80 where the user is located at present. In FIG. 10, a case is given where two electronic coupons, C1 and C5, are registered to the section 80 where the user is located at present.

The user selects on the coupon list screen 90 an electronic coupon that the user wishes to obtain (hereinafter referred to as “obtaining target electronic coupon”). Specifically, the user selects an obtaining target electronic coupon by selecting one of the coupon buttons 92. When an obtaining target electronic coupon is selected, a coupon screen is displayed.

FIG. 11 is an example of a coupon screen. A coupon screen 100 is a screen that displays details of an obtaining target electronic coupon. The coupon screen 100 of FIG. 11 displays a coupon 102. Further, a code image 104 is displayed. The coupon 102 and the code image 104 are the same as the coupon 62 and the code image 64 illustrated in FIG. 6.

The coupon screen 100 displays an obtaining button 106 and a back button 108. The back button 108 is a button for returning to the coupon list screen 90. When the user selects the obtaining button 106, the obtaining target electronic coupon is given to the user.

In the case where an electronic coupon registered by the user U1 is obtained by the user U2, for example, points are added to the game points of the user U1. Game points of a user thus increase each time an electronic coupon registered by the user is obtained by another user. Further, the advertisement system 1 publishes the game point ranking of users.

Described next is a series of operation steps for enabling the user to use an electronic coupon at a shop. The menu button 42C of FIG. 4 is a button for using an electronic coupon. When the menu button 42C is selected, the coupon list screen 50 (FIG. 5) is displayed.

The user selects one of the coupon buttons 52 on the coupon list screen 50, to thereby select an electronic coupon that the user uses at a shop. When one of the electronic coupons is selected, a coupon screen that displays details of the selected electronic coupon is displayed. This coupon screen is similar to the coupon screen 60 of FIG. 6, except that the registration button 66 is not displayed in this case.

When the user taps the code image 64 on the coupon screen, he displayed code image 64 is shown enlarged. The user can use the electronic coupon by presenting the enlarged code image 64 to the shop's clerk. When the code image 64 is read by the shop terminal 30, the fact that the electronic coupon has been used is notified to the advertisement server 10.

In the case where the user U2 obtains an electronic coupon registered by the user U1 and uses it at a shop by, for example, points are added to the shopping points of the user U1. Shopping points of a user thus increase each time an electronic coupon registered by the user is used by another user.

In the advertisement system 1 described above, a place where an electronic coupon can be registered is limited based on a past position of the user, and a user needs to actually visit the place to register an electronic coupon or the vicinity of that place.

Indiscriminate registration of a huge number of electronic advertisements is prevented as a result.

Further, in the advertisement system 1, a place where an electronic coupon can be registered is set based on the past position of a user and a user has to actually visit a place to which he registers an electronic coupon, which makes it difficult to register an electronic coupon to a place without actually seeing the place. Registering an electronic coupon to a place unsuitable as the setting where electronic coupons are provided is prevented as a result.

Further, the advertisement system 1 also sets the sections 80 through which the user has moved as places to which an electronic coupon can be registered. The sections 80 through which the user has moved are the sections 80 through which a man has passed. Setting the candidate region 76 in the manner described above therefore enables to present to users the sections 80 that are passable for men as regions to which an electronic coupon can be registered. Registering an electronic coupon to a place unsuitable as the setting where electronic coupons are provided is prevented as a result.

Further, an electronic coupon is registered to a region (a section 80) instead of a position in the advertisement system 1. In such a system, it needs to be avoided to register a plurality of identical coupons to places close to one another. Regarding this point, in the case where an electronic coupon is registered to a region, it is only necessary to, when registering a coupon to that region, simply check whether or not the same electronic coupon as the one to be registered is registered to that region. On the other hand, in the case where an electronic coupon is registered to a position, when registering a coupon to that position, it is necessary to search for the same electronic coupons registered to the vicinity of that position. By registering an electronic coupon to a region, it is thus enabled to simplify processing compared to the case where an electronic coupon is registered to a position.

Further, the advertisement system 1 awards game points to a user when an electronic coupon registered by that user is obtained by another user. Moreover, the advertisement system 1 publishes the game point ranking of users. As a result, a fun to compete for an amount of game points is given for users.

Further, the advertisement system 1 awards shopping points to a user when an electronic coupon registered by that user is obtained and used by another user.

In the advertisement system 1, for earning more game points and shopping points, users are motivated to register electronic coupons to more places or to register electronic coupons to places where it is likely that a registered coupon is obtained by more other users. Electronic advertising is performed actively and efficiently as a result.

Note that an electronic coupon may be used repeatedly, or an electronic coupon may be consumed once it is used. Further, it may be configured that a user is only allowed to register electronic coupons that are not used by that user himself. Also, it may be configured that once a user registers an electronic coupon, that coupon is set no longer usable. Moreover, the number of times that an electronic coupon can be used may be limited, and the number of times that an electronic coupon can be registered may be limited.

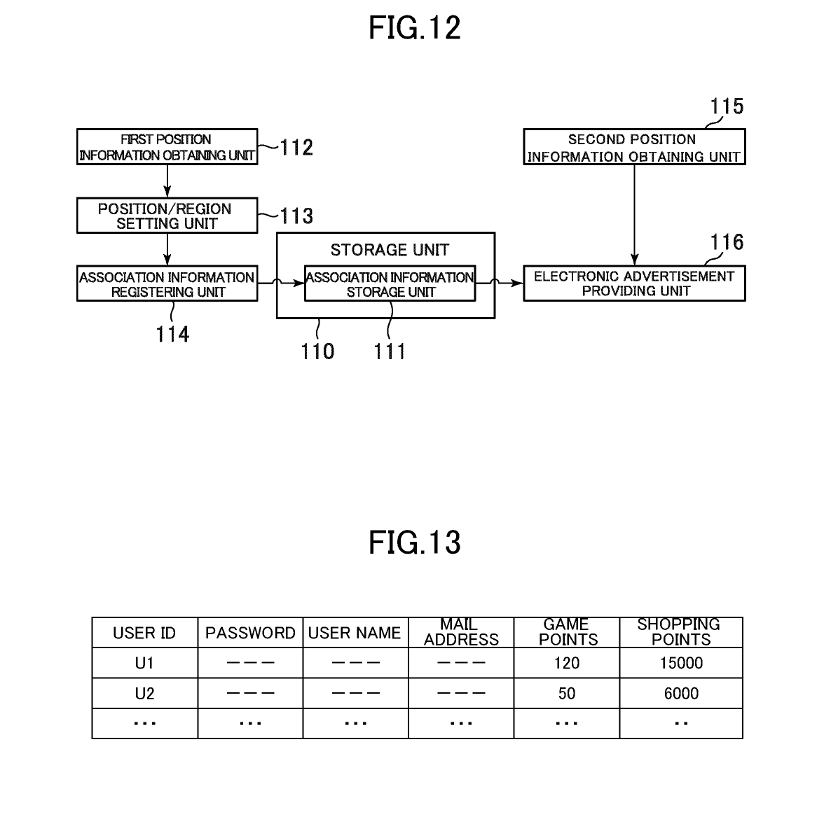

Function blocks implemented in the advertisement system 1 are described next. FIG. 12 is a function block diagram for illustrating function blocks that are implemented in the advertisement system 1. As illustrated in FIG. 12, the advertisement system 1 includes a storage unit 110, a first position information obtaining unit 112, a position/region setting unit 113, an association information registering unit 114, a second position information obtaining unit 115, and an electronic advertisement providing unit 116.

The storage unit 110 is described first. For example, the storage unit 110 is implemented by the database 15. The storing unit 110 stores information necessary to provide electronic advertisements. The storage unit 110 includes an association information storage unit 111. The association information storage unit 111 stores association information, which indicates association between an electronic advertisement and a region in the real space.

FIG. 13 to FIG. 19 are diagrams for showing an example of information that is stored in the storage unit 110. FIG. 13 is an example of a user table. The user table is a list of users who use services provided by the advertisement server 10. The user table includes, for example, a “user ID” field, a “password” field, a “user name” field, a “mail address” field, a “game point” field, and a “shopping point” field.

The “user ID” field indicates identification information for uniquely identifying a user. The “password” field indicates a password specified by the user. The “user name” field and the “mail address” field indicate the user's name and mail address, respectively. The “game point” field indicates the game points of the user. The “shopping point” field indicates the remaining shopping points that the user has.

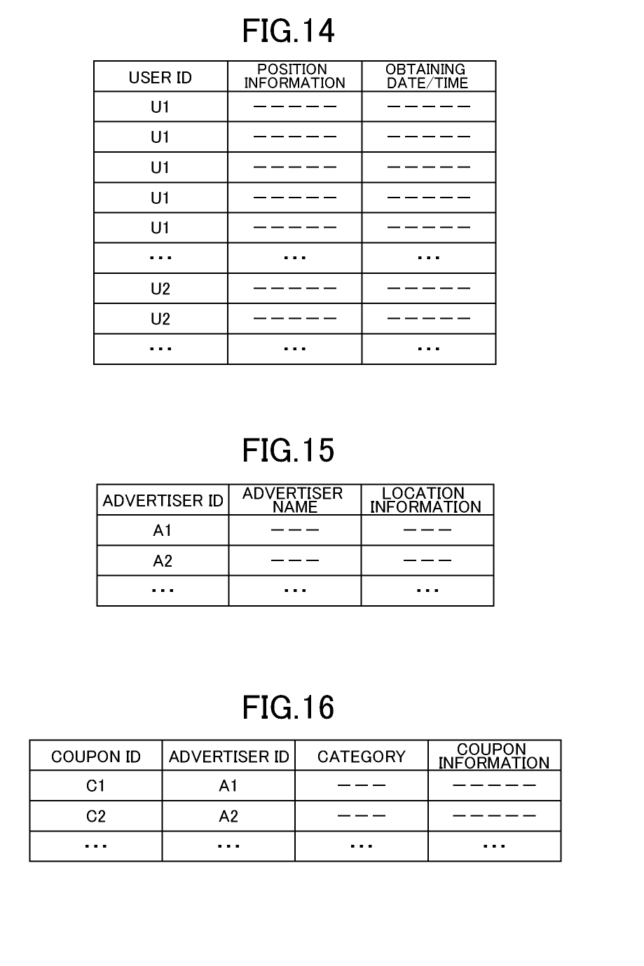

FIG. 14 is an example of a user position table. The user position table stores the N (N: an integer equal to or larger than 2) most recent pieces of the position information for each user.

The user position table includes, for example, a “user ID” field, a “position information” field, and an “obtaining date/time” field.

The “user ID” field indicates the user ID of a user. In the “position information” field, position information that has been received from the user terminal 20 is stored. The “obtaining date/time” field indicates a date/time at which the position information has been obtained.

In the advertisement system 1, an application program activated on the user terminal 20 regularly transmits position information of the user terminal 20 to the advertisement server 10. For example, the latest position information is transmitted to the advertisement server 10 each time position information is obtained. To give another example, the latest position information is transmitted to the advertisement server 10 at a given time interval. In still another example, the latest position information is transmitted to the advertisement server 10 when the cellular phone base station to which the user terminal 20 is connected for communication is switched to another cellular phone base station. Then, the “position information” field stores position information received from the user terminal 20.

In the case where the latest position information is transmitted to the advertisement server 10 at a given time interval, the transmission interval for when the application program is active (i.e., when a screen of the application program is displayed on the display unit 26) may be different from the transmission interval for when the application program is not active. For instance, the latest position information may be transmitted to the advertisement server 10 at a first time interval (e.g., 5 minutes) when the application program is active, and at a second time interval (e.g., 15 minutes), which is longer than the first time interval, when the application program is not active.

FIG. 15 is an example of an advertiser table. The advertiser table is a list of advertisers who use services provided by the advertisement server 10. The advertiser table includes, for example, an “advertiser ID” field, an “advertiser name” field, and a “location information” field.

The “advertiser ID” field indicates identification information for uniquely identifying an advertiser. The “advertiser name” field indicates the name of the advertiser. The “location information” field stores information that indicates the location of a shop run by the advertiser.

FIG. 16 is an example of an electronic coupon table. The electronic coupon table is a list of electronic coupons provided by the advertisement server 10. The electronic coupon table includes, for example, a “coupon ID” field, an “advertiser ID” field, a “category” field, and a “coupon information” field.

The “coupon ID” field indicates identification information for uniquely identifying an electronic coupon. The “advertiser ID” field indicates an advertiser ID assigned to the provider of the electronic coupon (advertiser). The “category” field indicates a category to which the electronic coupon belongs. The “coupon information” field stores information that indicates the specifics of the electronic coupon.

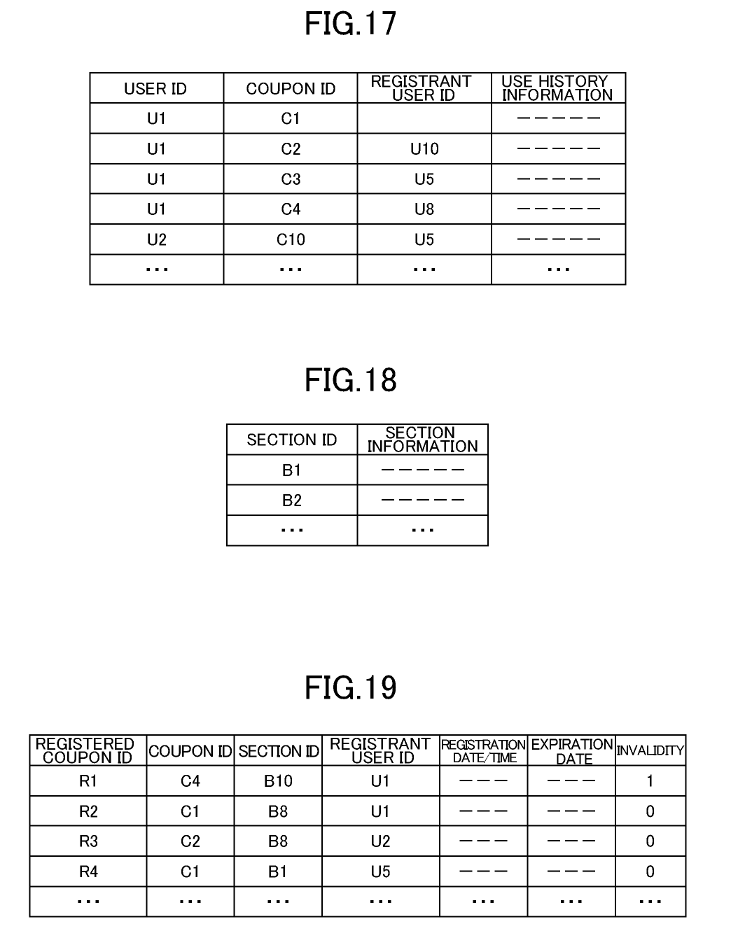

FIG. 17 is an example of a possession status table. The possession status table is a list of electronic coupons that each user possesses. The possession status table includes, for example, a “user ID” field, a “coupon ID” field, a “registrant user ID” field, and a “use history information” field.

The “user ID” field indicates the user ID of a user. The “coupon ID” field indicates the coupon ID of an electronic coupon. In the case where an electronic coupon registered by another user is obtained by the user, the user ID of the other user who has registered the electronic coupon is stored in the “registrant user ID” field. The “use history information” field stores information that indicates the use history of the electronic coupon by the user.

FIG. 18 is an example of a section table. The section table is a list of the plurality of sections 80 set in the real space. The section table includes, for example, a “section ID” field and a “section information” field.

The “section ID” field indicates identification information for uniquely identifying a section 80. Information for designating the section 80 is registered in the “section information” field. A section 80 is a rectangular region of a fixed size, and information that indicates the position (e.g., the latitude and the longitude) of a representative point (e.g., the center point, the upper left vertex, or the like) of the section 80 is stored in the “section information” field.

FIG. 19 is an example of a registration status table. The registration status table is a list of electronic coupons registered to regions in the real space. The registration status table includes, for example, a “registered coupon ID” field, a “coupon ID” field, a “section ID” field, a “registrant user ID” field, a “registration date/time” field, an “expiration date” field, and an “invalidity” field.

The “registered coupon ID” field indicates identification information for uniquely identifying an electronic coupon that is registered. The “coupon ID” field indicates the coupon ID of the registered electronic coupon. The “section ID” field indicates the section ID of the section 80 to which the electronic coupon is registered. The “registrant user ID” field indicates the user ID of a user who has registered the electronic coupon.

The “registration date/time” field indicates a date/time at which the electronic coupon has been registered. The “expiration date” field indicates the expiration date of the registered electronic coupon. For example, another date/time is registered, which is after an elapse of a given length of time (e.g., 3 hours) from the registration date/time, in the “expiration date” field.

The “invalidity” field indicates whether or not the registered electronic coupon is invalid. For example, a value “0” or “1” is registered in the “invalidity” field. The value “0” indicates that the electronic coupon is valid, and the value “1” indicates that the electronic coupon is invalid. The initial value of the “invalidity” field is set to “0”, and the value of the “invalidity” field is updated from “0” to “1” once it has passed the expiration date of the registered electronic coupon.

Note that each record in the registration status table described above shows an association between an electronic coupon and a section 80 (a region in the real space), and accordingly corresponds to the “association information” described above.

Described next are function blocks that enable a user to associate an electronic advertisement (for example, an electronic coupon) with a region in the real space (for example, a section 80). The first position information obtaining unit 112, the position/region setting unit 113, and the association information registering unit 114 correspond to these function blocks.

The first position information obtaining unit 112 is described. The first position information obtaining unit 112 is implemented on the user terminal 20 of a user who makes a request to associate an electronic advertisement with a region in the real space (a first user).

The first position information obtaining unit 112 obtains position information about the position of the user (the first user). For example, the first position information obtaining unit 112 obtains position information (the latitude and longitude) of the user terminal 20 based on signals received by the GPS reception unit 24. Alternatively, the first position information obtaining unit 112 may obtain the position information of the user terminal 20 based on which cellular phone base station is communicating with the user terminal 20. Still alternatively, the first position information obtaining unit 112 may also obtain the position information of the user terminal 20 based on which wireless LAN base station is communicating with the user terminal 20.

The first position information obtaining unit 112 obtains the position information of the user terminal 20 repeatedly. For instance, the first position information obtaining unit 112 obtains the position information of the user terminal 20 at a given time interval.

As described above, the position information of the user terminal 20 (namely, the position information obtained by the first position information obtaining unit 112) is transmitted regularly to the advertisement server 10 in this embodiment, and the N (N: an integer equal to or larger than 2) most recent pieces of position information are stored in the user position table.

For example, the latest position information is transmitted to the advertisement server 10 each time the position information is obtained. Alternatively, the latest position information may instead be transmitted to the advertisement server 10 at a given time interval. Still alternatively, the latest position information is transmitted to the advertisement server 10 when the cellular phone base station to which the user terminal 20 is connected for communication is switched to another cellular phone base station.

Note that it may be configured that history of position information obtained by the first position information obtaining unit 112 is stored in the storage unit 22 of the user terminal 20, and the user terminal 20 transmits, when an operation of request to associate an electronic advertisement with a region in the real space is performed, the position information history stored in the storage unit 22 at that time to the advertisement server 10. In the case where the position information history is transmitted from the user terminal 20 to the advertisement server 10, the user's agreement may be sought regarding the privacy.

In the example of FIG. 4 to FIG. 9, for instance, the operation of selecting the registration button 66 on the coupon screen 60 corresponds to the “operation of making a request to associate an electronic advertisement with a region in the real space”. The user terminal 20 may therefore transmit the position information history stored in the storage unit 22 at that time to the advertisement server 10 when the registration button 66 is selected.

The position/region setting unit 113 is described. The position/region setting unit 113 is implemented by the control unit 11 of the advertisement server 10. Specifically, the control unit 11 functions as the position/region setting unit 113 by executing a program.

When a request to associate an electronic advertisement with a region in the real space is received from a user, the position/region setting unit 113 sets a position or a region with which the electronic advertisement is to be associated based on position information that has been obtained, prior to the reception of the request, by the first position information obtaining unit 112 configured to obtain position information about the position of this user, or based on region information that includes the position information that has been obtained.

For example, the position/region setting unit 113 sets a position or a region with which the electronic advertisement is to be associated based on a given multiple number of pieces of the most recent position information that have been obtained by the first position information obtaining unit 112 prior to the reception of the above request, or based on region information that includes at least one of the given multiple number of pieces of position information.

Alternatively, the position/region setting unit 113 may set a position or a region with which the electronic advertisement is to be associated based on a plurality of pieces of position information of the most recent given period that have been obtained by the first position information obtaining unit 112 prior to the reception of the request, or based on region information that includes at least one of the plurality of pieces of position information. Note that the “most recent given period” is, for example, a period between the current time and a time point that precedes the current time by a given length of time. To give another example, the “most recent given period” may be a period between a time point at which the latest position information has been obtained and a time point at which previous position information that precedes the latest position information by M (M: an integer equal to or larger than 1) pieces of position information has been obtained.

In this embodiment, a given multiple number of the most recent pieces of the position information that have been obtained by the first position information obtaining unit 112 prior to the reception of the above request are stored in the user position table. The position/region setting unit 113 accordingly obtains, from the user position table, a plurality of pieces of position information associated with the user ID of the user who has made the above request, and uses these pieces of position information.

In the example of FIG. 4 to FIG. 9, for instance, when the registration button 66 of the coupon screen 60 is selected, the position/region setting unit 113 identifies the sections 80 through which the user has moved based on a plurality of pieces of position information of the user that are already stored in the user position table at that time point (namely, a plurality of pieces of position information obtained by the first position information obtaining unit 112 prior to that time point).

Specifically, the position/region setting unit 113 identifies the sections 80 that include each piece of position information described above as the sections 80 through which the user has moved. In another example, the position/region setting unit 113 identifies, as the sections 80 through which the user has moved, the sections 80 that include a line connecting positions that are indicated by the above plurality of pieces of position information (the line 75 in FIG. 7).

In the case where information indicating the latitude and the longitude that are calculated based on the reception result of the GPS reception unit 24 is used as the above position information, for example, the position/region setting unit 113 identifies the section 80 that includes the latitude and the longitude as the section 80 through which the user has moved. In another example, the position/region setting unit 113 identifies, as the sections 80 through which the user has moved, the sections 80 that include a line connecting a plurality of latitudes and longitudes (the line 75 in FIG. 7).

In the case where information that is obtained based on which cellular phone base station is communicating with the user terminal 20 is used as the above position information, for another example, the position/region setting unit 113 may identify the sections 80 that are included in the communication range of the cellular phone base station as the sections 80 through which the user has moved. Alternatively, in the case where information that is obtained based on which wireless LAN base station is communicating with the user terminal 20 is used as the above position information, the position/region setting unit 113 may identify the sections 80 that are included in the communication range of the wireless LAN base station as the sections 80 through which the user has moved.

As described above, it may be configured that a history of position information obtained by the first position information obtaining unit 112 is stored in the storage unit 22 of the user terminal 20, and the user terminal 20 transmits, when the registration button 66 of the coupon screen 60 is selected, the position information history that is stored in the storage unit 22 at the time to the advertisement server 10. In this case, the position/region setting unit 113 identifies the sections 80 through which the user has moved based on the history of the above position information transmitted from the user terminal 20.

The position/region setting unit 113 identifies the sections 80 through which the user has moved in the manner described above, and sets the sections 80 through which the user has moved as the sections 80 to which the electronic coupon is to be registered (registration target regions).

Specifically, the position/region setting unit 113 identifies a plurality of sections 80 through which the user has moved in the manner described above, and has the user terminal 20 display the section designating screen 70 to thereby present the plurality of sections 80 through which the user has moved to the user as the candidate region 76.

Then the position/region setting unit 113 receives the designation of at least one of the plurality of sections 80 presented as the candidate region 76 from the user. Further, the position/region setting unit 113 sets the section 80 designated by the user as a registration target region.

Note that the position/region setting unit 113 may, without receiving the user's designation, automatically set at least one of the plurality of sections 80 through which the user has moved as a registration target region. For instance, the position/region setting unit 113 may set, at random, at least one of the plurality of sections 80 through which the user has moved as a registration target region.

The association information registering unit 114 is described next. The association information registering unit 114 is implemented by the control unit 11 of the advertisement server 10. Specifically, the control unit 11 functions as the association information registering unit 114 by executing a program.

The association information registering unit 114 registers association information, which indicates the association between a registration target electronic advertisement and a position or a region set by the position/region setting unit 113, in the association information storage unit 111.

In the example of FIG. 4 to FIG. 9, for instance, the association information registering unit 114 adds, to the registration status table, a record that indicates the association between a registration target electronic coupon (i.e., the electronic coupon selected on the coupon list screen 50) and the registration target region (i.e., the section 80 designated on the section designating screen 70).

Function blocks that enable a user to obtain an electronic advertisement associated with a region in the real space are described next. The second position information obtaining unit 115 and the electronic advertisement providing unit 116 correspond to these function blocks.

The second position information obtaining unit 115 is described. The second position information obtaining unit 115 is implemented on the user terminal 20 of a user who makes a request to provide an electronic advertisement (a second user).

The second position information obtaining unit 115 obtains position information about the position of the user (the second user). For example, the second position information obtaining unit 115 obtains position information (the latitude and longitude) of the user terminal 20 based on signals received by the GPS reception unit 24. Alternatively, the second position information obtaining unit 115 may obtain the position information of the user terminal 20 based on which cellular phone base station is communicating with the user terminal 20. Still alternatively, the second position information obtaining unit 115 may obtain the position information of the user terminal 20 based on which wireless LAN base station is communicating with the user terminal 20.

The second position information obtaining unit 115 obtains the position information of the user terminal 20 repeatedly. For instance, the second position information obtaining unit 115 obtains the position information of the user terminal 20 at a given time interval.

As described above, the position information of the user terminal 20 (namely, the position information obtained by the second position information obtaining unit 115) is transmitted regularly to the advertisement server 10 in this embodiment, and the N (N: an integer equal to or larger than 2) most recent pieces of the position information are stored in the user position table.

For example, the latest position information is transmitted to the advertisement server 10 each time the position information is obtained. Alternatively, the latest position information is transmitted to the advertisement server 10 at a given time interval. Still alternatively, the latest position information is transmitted to the advertisement server 10 when the cellular phone base station to which the user terminal 20 is connected for communication is switched to another cellular phone base station.

Instead of regularly transmitting position information of the user terminal 20 to the advertisement server 10, it may be configured to transmit the latest position information of the user terminal 20 to the advertisement server 10 when operated so as to make a request to provide an electronic advertisement.

In the example of FIG. 10 and FIG. 11, for instance, the operation of selecting the obtaining button 106 on the coupon screen 100 corresponds to the “operation of making a request to provide an electronic advertisement”. It may therefore be configured to transmit the latest position information of the user terminal 20 to the advertisement server 10 when the obtaining button 106 is selected. In this case, the most recent pieces of the position information already obtained at the time the obtaining button 106 is selected may be transmitted to the advertisement server 10 as the latest position information, or position information of the user terminal 20 maybe newly obtained to transmit the newly obtained position information to the advertisement server 10 as the latest position information.

The electronic advertisement providing unit 116 is described. The electronic advertisement providing unit 116 is implemented by the control unit 11 of the advertisement server 10. Specifically, the control unit 11 functions as the electronic advertisement providing unit 116 by executing a program.

When a request to provide an electronic advertisement is received from a user (the second user), the electronic advertisement providing unit 116 extracts an electronic advertisement to be provided to this user from among electronic advertisements that are registered in the association information storage unit 111, based on position information of the user obtained by the second position information obtaining unit 115 and positions or regions registered in the association information storage unit 111, and provides the extracted electronic advertisement to the user.

In the example of FIG. 10 and FIG. 11, for instance, the electronic advertisement providing unit 116 provides the user an electronic coupon registered to the section 80 that includes a position indicated by the position information obtained by the second position information obtaining unit 115.

Note that the electronic advertisement providing unit 116 may provide the user with not only electronic coupons registered to the section 80 that includes the position indicated by the position information obtained by the second position information obtaining unit 115 but also electronic coupons registered to the sections 80 that are located around this section 80. For instance, the electronic advertisement providing unit 116 may provide the user also with electronic coupons that are registered to eight sections 80 surrounding the section 80 that includes the indicated position.

Alternatively, the electronic advertisement providing unit 116 may instead provide the user with electronic coupons registered to the sections 80 that are within a reference distance from the position indicated by the position information obtained by the second position information obtaining unit 115.

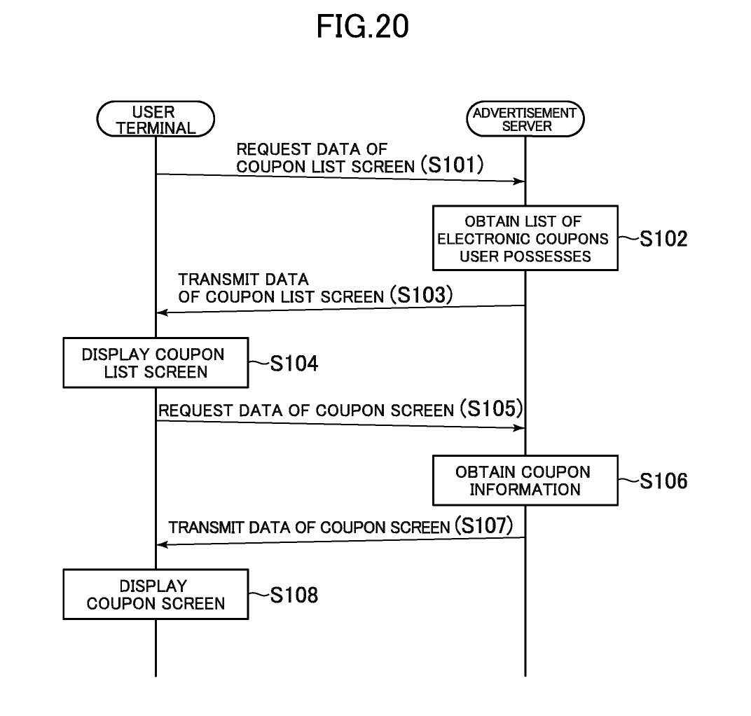

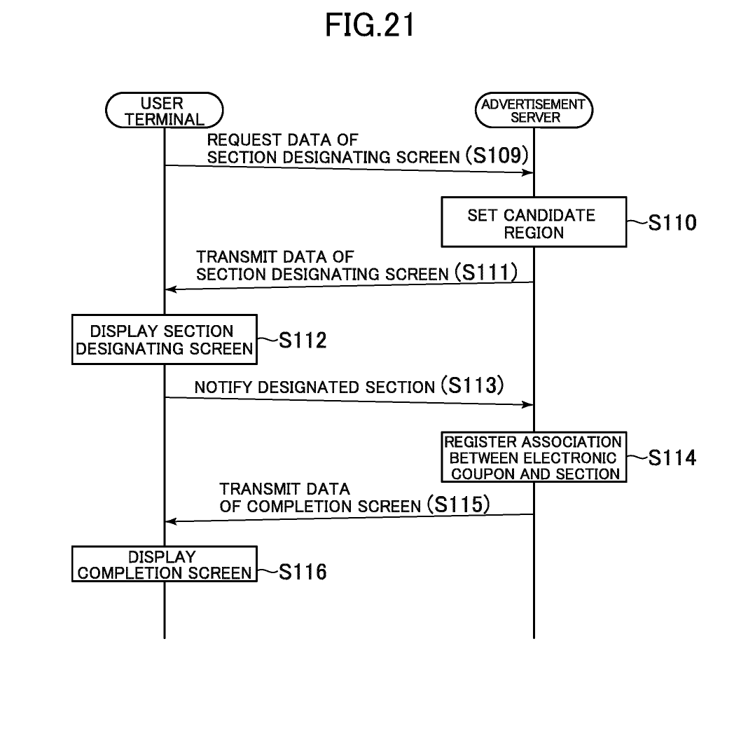

Processing executed in the advertisement system 1 is described next. FIG. 20 and FIG. 21 are diagrams for illustrating an example of processing that is executed when the menu button 42A of the menu screen 40 is selected. The control unit 11 of the advertisement server 10 executes the processing of FIG. 20 and FIG. 21 according to a program, to thereby function as the position/region setting unit 113 and the association information registering unit 114.

When the menu button 42A of the menu screen 40 is selected, the control unit 21 of the user terminal 20 makes a request for data of the coupon list screen 50 to the advertisement server 10 (S101). In this case, the user ID of the user is transmitted to the advertisement server 10.

When the above request is received by the advertisement server 10, the control unit 11 of the advertisement server 10 obtains a list of electronic coupons that the user possesses (S102). The control unit 11 accesses the possession status table and obtains a record in which the user ID received from the user terminal 20 is stored in the “user ID” field, to thereby obtain a list of electronic coupons that the user possesses. Based on the obtained list, the control unit 11 then generates data of the coupon list screen 50 and transmits the generated data to the user terminal 20 (S103). Further, based on this data, the control unit 21 of the user terminal 20 displays the coupon list screen 50 on the display unit 26 (S104).

The control unit 21 monitors whether or not any one of the coupon buttons 52 has been selected while the coupon list screen 50 is displayed on the display unit 26. In the case where one of the coupon buttons 52 is selected, the control unit 21 requests data of the coupon screen 60 to the advertisement server 10 (S105). In this case, the user ID of the user and the coupon ID of an electronic coupon that corresponds to the coupon button 52 selected by the user (namely, the registration target electronic coupon) are transmitted to the advertisement server 10.

When the advertisement server 10 receives the above request, the control unit 11 of the advertisement server 10 obtains coupon information (S106). Specifically, the control unit 11 accesses the electronic coupon table and obtains a record in which the coupon

ID received from the user terminal 20 is stored in the “coupon ID” field. Then, based on information stored in each field of the obtained record, the control unit 11 generates data of the coupon screen 60. Note that at this moment, the control unit 11 generates the code image 64 obtained by making a combination of a user ID, a coupon ID, and a registrant user ID into a code.

The control unit 11 transmits the data of the coupon screen 60 to the user terminal 20 (S107). Further, based on this data, the control unit 21 of the user terminal 20 displays the coupon screen 60 on the display unit 26 (S108).

The control unit 21 monitors whether or not the registration button 66 is selected while the coupon screen 60 is displayed on the display unit 26. In the case where the registration button 66 is selected, the control unit 21 requests data of the section designating screen 70 to the advertisement server 10 as illustrated in FIG. 21 (S109). In this case, the user ID of the user and the coupon ID of the registration target electronic coupon are transmitted to the advertisement server 10.

When the advertisement server 10 receives the above request, the control unit 11 of the advertisement server 10 sets the candidate region 76 (S110). The control unit 11 first accesses the user position table to read a plurality of pieces of position information of the user. Further, based on the read pieces of position information and the section table, the control unit 11 identifies the sections 80 through which the user has moved. For example, the control unit 11 sets, as the candidate region 76, a plurality of sections 80 that include the line 75 connecting the user positions 74A to 74E in order as illustrated in FIG. 9.

Note that the control unit 11 accesses the registration status table to determine whether or not the sections 80 through which the user has moved include a section 80 to which the same electronic coupon as the registration target electronic coupon is registered. In the case where such a section 80 is included, the control unit 11 does not set that section 80 as a part of the candidate region 76.

Thereafter, the control unit 11 generates data of the section designating screen 70 and transmits the generated data to the user terminal 20 (S111). Further, based on this data, the control unit 21 of the user terminal 20 displays the section designating screen 70 on the display unit 26 (S112). By having the section designating screen 70 displayed, the sections 80 set as the candidate region 76 in Step S110 is presented to the user.

The control unit 21 monitors whether or not any one of the plurality of sections 80 set as the candidate region 76 while the section designating screen 70 is displayed on the display unit 26. In the case where one of the sections 80 is designated, the control unit 21 notifies the section 80 designated by the user to the advertisement server 10 (S113). In this case, the user ID of the user, the coupon ID of the registration target electronic coupon, and the section ID of the section 80 designated by the user are transmitted to the advertisement server 10.

When the advertisement server 10 receives the above notification, the control unit 11 (the position/region setting unit 113 and the association information registering unit 114) of the advertisement server 10 makes the section 80 designated by the user to be the section 80 that is the registration target, and registers the association between the registration target electronic coupon and the section 80 that is the registration target (S114).

Specifically, the control unit 11 adds a new record to the registration status table. Then, the control unit 11 newly generates a registered coupon ID and registers the registered coupon ID in the “registered coupon ID” field of the above new record.

Further, the control unit 11 registers the coupon ID received from the user terminal 20 in the “coupon ID” field of the above new record. The control unit 11 then registers the section ID received from the user terminal 20 in the “section ID” field of the above new record. The control unit 11 registers the user ID received from the user terminal 20 in the “registrant user ID” field of the above new record.

Moreover, the control unit 11 registers the current date/time in the “registration date/time” field of the above new record, and registers another date/time which is after an elapse of a given length of time from the current date/time in the “expiration date” field of the above new record. Also, the control unit 11 registers the value “0” in the “invalidity” field of the above new record.

When the processing of Step S114 is completed, the control unit 11 transmits data of a completion screen that indicates normal completion of the associating process to the user terminal 20 (S115). The completion screen is then displayed on the display unit 26 of the user terminal 20 (S116). In the above way, the processing executed when the menu button 42A of the menu screen 40 is selected is completed

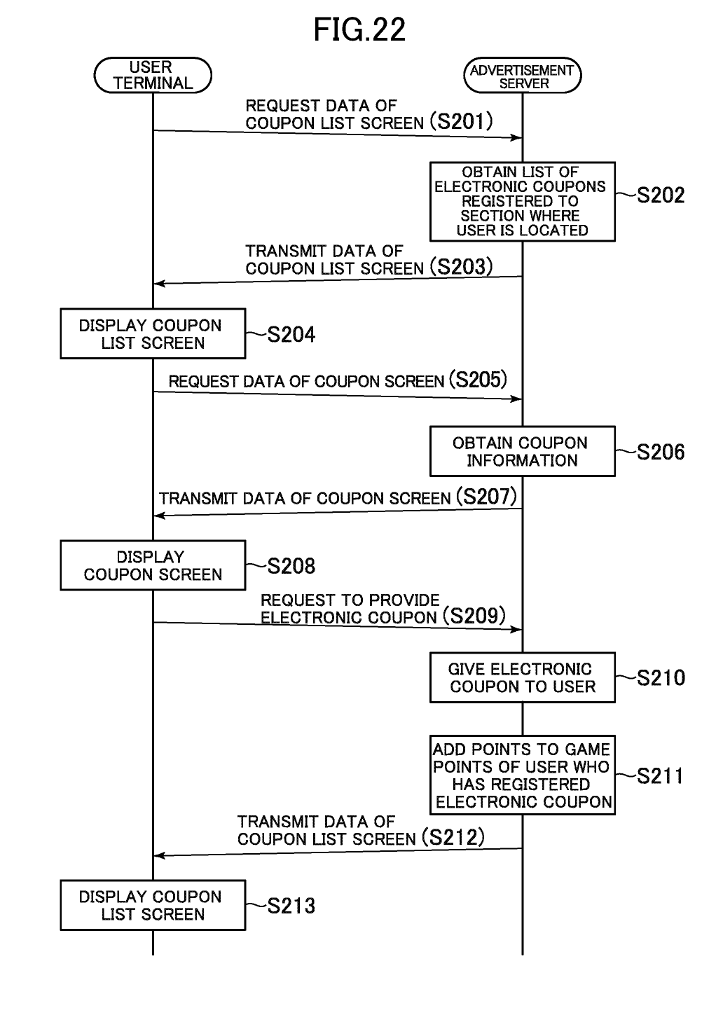

FIG. 22 is a diagram for illustrating an example of processing that is executed when the menu button 42B of the menu screen 40 is selected. The control unit 11 of the advertisement server 10 executes the processing of FIG. 22 according to a program, to thereby function as the electronic advertisement providing unit 116.

When the menu button 42B of the menu screen 40 is selected, the control unit 21 of the user terminal 20 requests data of the coupon list screen 90 to the advertisement server 10 (S201). In this case, the user ID of the user is transmitted to the advertisement server 10.

When the advertisement server 10 receives the above request, the control unit 11 of the advertisement server 10 obtains a list of electronic coupons that are registered to the section 80 where the user is located (S202). In other words, the control unit 11 obtains a list of electronic coupons that are available to the user. First, the control unit 11 accesses the user position table to read the latest position information of the user. The control unit 11 also accesses the section table to obtain the section ID of the section 80 that includes a position indicated by the read position information. The control unit 11 further accesses the registration status table and obtains a record in which the obtained section ID is stored in the “section ID” field and the value “0” is registered in the “invalidity” field, to thereby obtain a list of electronic coupons that are registered to the section 80 where the user is located.

Then, the control unit 11 generates data of the coupon list screen 90 based on the result obtained in Step S202, and transmits the generated data to the user terminal 20 (S203). Based on this data, the control unit 21 of the user terminal 20 displays the coupon list screen 90 on the display unit 26 (S204).

The control unit 21 monitors whether or not any one of the coupon buttons 92 has been selected while the coupon list screen 90 is displayed on the display unit 26. In the case where one of the coupon buttons 92 is selected, the control unit 21 requests data of the coupon screen 100 to the advertisement server 10 (S205). In this case, the user ID of the user who is using the user terminal 20 and the coupon ID of an electronic coupon that corresponds to the coupon button 92 selected by the user (namely, the obtaining target electronic coupon) are transmitted to the advertisement server 10.

When the advertisement server 10 receives the above request, the control unit 11 of the advertisement server 10 obtains coupon information (S206). Specifically, the control unit 11 accesses the electronic coupon table and obtains a record in which the coupon ID received from the user terminal 20 is stored in the “coupon ID” field. Then, based on information stored in each field of the obtained record, the control unit 11 generates data of the coupon screen 100. Note that at this moment, the control unit 11 generates the code image 104 obtained by making a combination of a user ID, a coupon ID, and a registrant user ID into a code.

The control unit 11 transmits the data of the coupon screen 100 to the user terminal 20 (S207). Based on this data, the control unit 21 of the user terminal 20 displays the coupon screen 100 on the display unit 26 (S208).

The control unit 21 monitors whether or not the obtaining button 106 has been selected while the coupon screen 100 is displayed on the display unit 26. In the case where the obtaining button 106 is selected, the control unit 21 requests the advertisement server 10 to provide the electronic coupon (S209). In this case, the user ID of the user and the registered coupon ID of the obtaining target electronic coupon are transmitted to the advertisement server 10.

When the advertisement server 10 receives the above request, the control unit 11 (the electronic advertisement providing unit 117) of the advertisement server 10 gives the electronic coupon to the user (S210).

First, the control unit 11 accesses the registration status table to obtain a coupon ID and a registrant user ID that are associated with the registered coupon ID received from the user terminal 20. Specifically, the control unit 11 reads a record in which the registered coupon ID is stored in the “registered coupon ID” field and obtains a coupon ID and a registrant user ID that are stored in the “coupon ID” field and the “registrant user ID” field of the record.

Moreover, the control unit 11 adds a new record to the possession status table. Then, the control unit 11 registers the user ID received from the user terminal 20 in the “user ID” field of the above new record. The control unit 11 also registers the coupon ID and the registrant user ID obtained from the registration status table in the “coupon ID” field and the “registrant user ID” field of the above new record.

Thereafter, the control unit 11 adds points to the game points of the user who has registered the electronic coupon given in Step S210 to the user (S211). Specifically, the control unit 11 accesses a record in which the registrant user ID obtained in Step S210 from the registration status table is stored in the “user ID” field, out of the records of the user table, and adds a given value to the value of the “game point” field in this record.

After executing Step S211, the control unit 11 generates data of the coupon list screen 50 and transmits the generated data to the user terminal 20 (S212). Then, the user terminal 20 displays the coupon list screen 50 on the display unit 26 based on this data (S213). In the above way, the processing that is executed when the menu button 42B of the menu screen 40 is selected is completed.

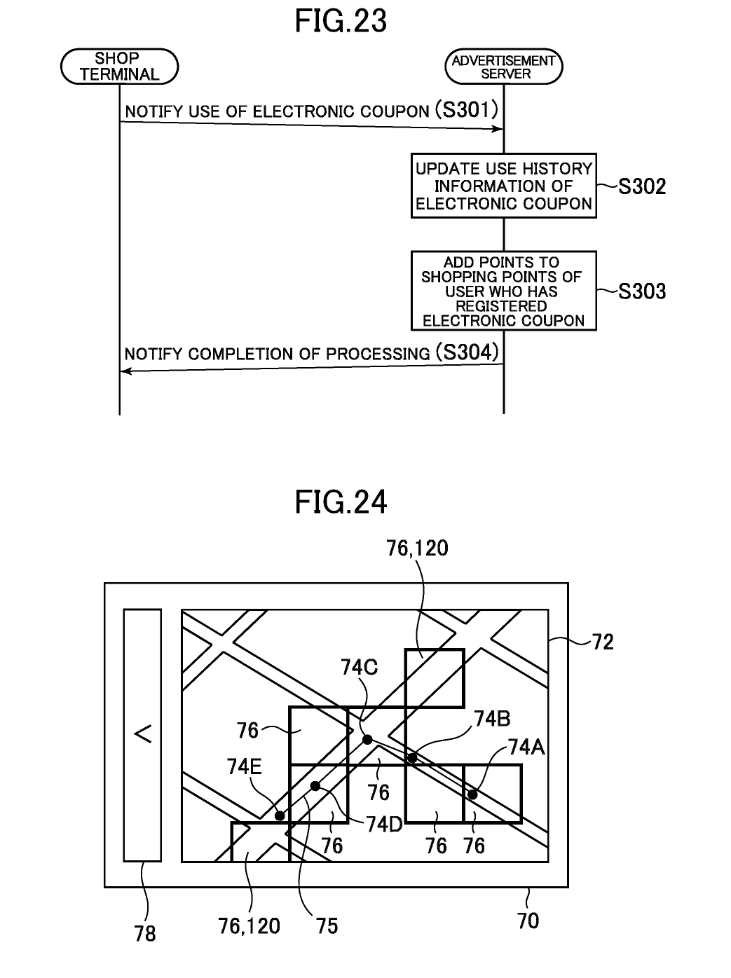

FIG. 23 is a diagram for illustrating an example of processing that is executed when an electronic coupon is used at a shop. In other words, it illustrates an example of processing that is executed when the code image 64 displayed on the display unit 26 of the user terminal 20 is read by the shop terminal 30.

As illustrated in FIG. 23, when an electronic coupon is used at a shop, the shop terminal 30 notifies the advertisement server 10 of the fact that the electronic coupon has been used (S301). In this case, the shop terminal 30 reads a user ID, a coupon ID, and a registrant user ID from the code image 64, and transmits the user ID, the coupon ID, and the registrant user ID to the advertisement server 10.

When the advertisement server 10 receives the above notification, the control unit 11 of the advertisement server 10 updates the use history information of the electronic coupon (S302). Specifically, the control unit 11 accesses a record in which the user ID and the coupon ID received from the user terminal 20 are stored in the “user ID” field and the “coupon ID” field, out of the records of the possession status table, and updates the “use history information” field of the record.

Further, the control unit 11 adds points to the shopping points of the user who has registered the used coupon (S303). Specifically, the control unit 11 accesses a record in which the registrant user ID received from the user terminal 20 is stored in the “user ID” field, out of the records of the user table, and adds a given value to the value of the “shopping point” field of the record.

After executing Step S303, the control unit 11 notifies the completion of the processing to the shop terminal 30 (S304). In the above way, the processing that is executed when an electronic coupon is used at a shop is completed.

According to the advertisement system 1 according to the first embodiment described above, a place where an electronic coupon can be registered is set based on the past position of the user. Therefore, to register an electronic coupon, a user needs to actually visit the place to which he wants to register the electronic coupon or the vicinity of that place. Indiscriminate registration of a huge number of electronic advertisements can be prevented as a result. Further, Registering an electronic coupon to a place unsuitable as the setting where electronic coupons are provided can be prevented as well.

Further, according to the advertisement system 1, the sections 80 through which the user has moved are set as places to which an electronic coupon can be registered. The sections 80 through which the user has moved are the sections 80 where there is a fair amount of traffic of men, and according to the advertisement system 1, it becomes possible to present, to users, the sections 80 that have a fair amount of traffic of men as regions to which an electronic coupon can be registered. Registering an electronic coupon to a place unsuitable as the setting where electronic coupons are provided can be prevented as a result.

Further, in the advertisement system 1, based on previously obtained position information (position information stored in the user position table) the processing is executed (Step S110 of FIG. 21) when a user makes a request to register an electronic coupon (namely, when the registration button 66 of the coupon screen 60 is selected). This eliminates the need to newly obtain position information of the user terminal 20 when a request to register an electronic coupon is made by the user, and hence a response can be quickened accordingly.

Moreover, the advertisement system 1 awards game points to a user when an electronic coupon registered by that user is obtained by another user. The advertisement system 1 also awards shopping points to a user when an electronic coupon registered by that user is obtained and used by another user. According to the advertisement system 1, it becomes possible to give to users a fun to compete for an amount of game points. It also becomes possible to promote active and efficient electronic advertising.

Note that in the embodiment described above, an electronic coupon is associated with a region (a section 80) instead of a position. According to this embodiment, it becomes possible to simplify processing for preventing multiple registrations of a single electronic coupon to places close to one another.

The present invention is not limited to the embodiment described above.

[1] For example, while a plurality of sections 80 are set in advance in the embodiment described above, it is not necessary to set a plurality of sections 80 in advance.

For instance, the position/region setting unit 113 may identify, as a region through which the user has moved, a region that includes a position indicated by position information obtained by the first position information obtaining unit 112. Specifically, the position/region setting unit 113 identifies, as a region through which the user has moved, a region that is centered around a position indicated by position information obtained by the first position information obtaining unit 112 (e.g., a rectangular region or a circular region). Then, the position/region setting unit 113 may set the identified region as the candidate region 76.

In the case where information indicating the latitude and the longitude that is calculated based on the reception result of the GPS reception unit 24 is used as the above position information, for example, the position/region setting unit 113 may identify a region that includes the latitude and the longitude as a region through which the user has moved.

Alternatively, in the case where information that is obtained based on which cellular phone base station is communicating with the user terminal 20 is used as the above position information, the position/region setting unit 113 may identify the communication range itself of the cellular phone base station, or a region that includes the communication range of the cellular phone base station, as a region through which the user has moved. Still alternatively, in the case where information that is obtained based on which wireless LAN base station is communicating with the user terminal 20 is used as the above position information, the position/region setting unit 113 may identify the communication range itself of the wireless LAN base station, or a region that includes the communication range of the wireless LAN base station, as a region through which the user has moved.

[2] For example, the advertisement system 1 (the advertisement server 10) may include an estimation unit described below.

When a request to associate an electronic advertisement with a region in the real space is received from a user (the first user), the estimation unit estimates the current position of the user, or a region where the user is located at present, based on position information that has been obtained by the first position information obtaining unit 112 prior to the reception of the request, or based on region information that includes the already obtained position information.

It is assumed here that in the example of FIG. 9, the position 74A is the latest user position, and the position 74B is the user position immediately before the latest one. In this case, the estimation unit first calculates a moving speed at which the user has moved from the position 74B to the position 74A. Specifically, the estimation unit calculates the distance between the position 74A and the position 74B, and calculates the length of time between an obtaining date/time of position 74A and an obtaining date/time of the position 74B. Then, based on the calculated distance and length of time, the estimation unit calculates the moving speed.

The estimation unit further calculates an elapsed time that has passed since the obtaining date/time of the position 74A. The estimation unit then estimates the current position of the user by assuming that the user has moved in an extending direction of a straight line running from the position 74B to the position 74A, at the calculated moving speed for the calculated elapsed time above. In other words, the estimation unit estimates the section 80 where the user is located at present by assuming that the user has moved in an extending direction of a straight line running from the position 74B to the position 74A at the calculated moving speed above for the calculated elapsed time above.

In this modification example, the position/region setting unit 113 sets a position or a region with which an electronic advertisement is to be associated based on an estimation made by the estimation unit about the user's current position, or about the section 80 where the user is located at present.

For instance, the position/region setting unit 113 sets, as the candidate region 76, the section 80 that is estimated by the estimation unit as a section where the user is located at present. Further, in this case, the position/region setting unit 113 may additionally set, as the candidate region 76, sections surrounding the estimated section 80 (e.g., the four or eight adjacent sections 80 that surround the estimated section 80 from four directions or eight directions).

Note that this modification example may be combined with Modification Example 1 described above, for example. Specifically, the position/region setting unit 113 may set a region that includes the user's current position estimated by the estimation unit as a region with which the electronic advertisement is to be associated. For example, the position/region setting unit 113 may set, as a region with which the electronic advertisement is to be associated, a region (e.g., a rectangular region or circular region) that is centered around the user's current position estimated by the estimation unit. To give another example, the position/region setting unit 113 may set, as a position with which the electronic advertisement is to be associated, the user's current position that is estimated by the estimation unit.

[3] The position/region setting unit 113 may set the user's past position as a position with which an electronic advertisement is to be associated.

In the example of FIG. 4 to FIG. 9, for instance, the position/region setting unit 113 presents the plurality of user positions 74A to 74E to the user. Specifically, the position/region setting unit 113 presents the plurality of user positions 74A to 74E to the user, by having the user terminal 20 display the section designating screen 70. However, the candidate region 76 does not need to be displayed on the section designating screen 70 in this case.

The position/region setting unit 113 then receives the designation of at least one of the plurality of user positions 74A to 74E from the user. Further, the position/region setting unit 113 sets, as a position with which the electronic coupon is to be associated, the position designated by the user out of the plurality of positions 74A to 74E.

Further, in this case, it is only necessary that the electronic advertisement providing unit 116 provides a user with electronic coupons registered to positions inside a region apart from a position indicated by information that is obtained by the second position information obtaining unit 115, by a distance equal to or less than a reference distance.

Note that the position/region setting unit 113 may set at least one of the plurality of user positions 74A to 74E as a position to which the electronic coupon is to be registered, without receiving the user's designation. For instance, the position/region setting unit 113 may set, at random, at least one of the plurality of user positions 74A to 74E as a position with which the electronic coupon is to be associated.

[4] As described above, the position/region setting unit 113 does not set, as a candidate region 76, the section 80 to which an electronic advertisement having a given relationship with the registration target electronic advertisement is already registered. In such cases, the position/region setting unit 113 may set a substitute region for the above section 80 that is not set as a part of the candidate region 76, based on information that is obtained by the first position information obtaining unit 112, and set the substitute region as a candidate region 76.

FIG. 24 is an example of the section designating screen 70 of when a substitute region is added to the candidate region. In the example of FIG. 24, two sections 80 are excluded from the candidate region 76 as in the example of FIG. 9. Specifically, the section 80 that includes the user position 74B and the section 80 that includes the user position 74E are not set as a candidate region 76. However, two sections 80 are set as substitute regions 120 from among sections 80 other than those where the user has moved, and are added to the candidate region 76.

Specifically, the section 80 (upwardly) adjacent to the section that includes the user position 74B and the section 80 (downwardly) adjacent to the section 80 that includes the user position 74E are set as the substitute regions 120 to be added to the candidate region 76 as a result.

[4-1] Note that the position/region setting unit 113 may select the substitute region 120 from among the sections 80 that include a particular road. Specifically, the position/region setting unit 113 may select, as the substitute region 120, the section 80 the distance of which from the candidate region 76 (or from the user's position) is less than a reference distance and which includes a particular road.

A “particular road” used here is a major road, and is, for example, a road where traffic of men is heavy. Further, the “distance from the candidate region 76” may be the distance from the center of the candidate region 76, or the distance from the border of the candidate region 76.

Information indicating whether or not a particular road is included is stored for each section 80 in this case. For example, a “particular road” field is added to the section table to store information indicating whether or not the section 80 includes a particular road in the “particular road” field. Further, the position/region setting unit 113 determines whether or not the section 80 includes a particular road based on this section table, and sets the substitute region 120 based on the result of the determination. Note that the position/region setting unit 113 may refer to road map information to determine whether or not the section 80 includes a particular road.

By configuring as above, the section 80 that has heavy traffic of men is set to be the candidate region 76, as the substitute region 120. In short, this allows the user to designate the section 80 that has heavy traffic of men as a registration target region.

[4-2] To give another example, the position/region setting unit 113 may select the substitute region 120 out of the sections that include a particular facility. Specifically, the position/region setting unit 113 may select, as the substitute region 120, the section 80 the distance of which from the candidate region 76 (or from the user's position) is less than a reference distance and which includes a particular facility.

A “particular facility” used here is a facility where people tend to gather, and is, for example, a convenience store or the like.

In this case, information indicating whether or not a particular facility is included is stored for each section 80 in this case. For example, a “particular facility” field is added to the section table to store information indicating whether or not the section 80 includes a particular facility in the “particular facility” field. Further, the position/region setting unit 113 determines whether or not the section 80 includes a particular facility based on this section table, and then sets the substitute region 120 based on the result of this determination. Note that the position/region setting unit 113 may refer to roadmap information to determine whether or not the section 80 includes a particular facility.

By configuring as above, the section 80 where people tend to gather is set to be the candidate region 76, as the substitute region 120. In short, this allows the user to designate the section 80 where people tend to gather as a registration target region.

[4-3] To give another example, the position/region setting unit 113 may set the substitute region 120 based on the volume of traffic of men.

Information indicating the volume of traffic of men is stored for each section 80 in this case. For example, a “traffic volume” field is added to the section table to store information about the traffic volume of the section 80 in the “traffic volume” field. Then, the position/region setting unit 113 selects the substitute region 120 based on the section table.

The position/region setting unit 113 selects the substitute region 120 based on the traffic volume of each section 80, out of the sections 80 whose distance from the candidate region 76 (or from the user's position) is less than a reference distance. For example, the position/region setting unit 113 selects the sections 80 as the substitute region 120 in descending order of traffic volume. To give another example, the position/region setting unit 113 may select the section 80 where the traffic volume is equal to or more than a reference volume as the substitute region 120.

By configuring as above, the section 80 that has heavy traffic of men is set to be the candidate region 76, as the substitute region 120. In other words, this allows the user to designate the section 80 that has heavy traffic of men as a registration target region.

[5] For example, the position/region setting unit 113 may limit a position or a region with which an electronic coupon is to be associated to a region that is within a reference distance from the location of a shop of the issuer (advertiser) of the electronic coupon.

In the example of FIG. 8, for instance, the position/region setting unit 113 may set only the sections 80 that are within the reference distance from the location of the above shop as the candidate region 76, out of the plurality of sections 80 through which the user has moved.

[6] For example, the control unit 11 may determine whether or not the distance between the user's position at a first time point, which precedes the reception of a request to associate an electronic advertisement with a region in the real space, and the user's position at a second time point, which precedes the first time point, is greater than an upper threshold. Then, the control unit 11 may reject the request for electronic coupon registration from this user when the above distance is greater than the upper threshold. In short, the control unit 11 may inhibit the registration of association information.

Determining whether or not the above distance is greater than the upper threshold may be executed on the user terminal 20. The result of the determination may then be transmitted to the advertisement server 10.

Alternatively, it may be configured not to transmit the request to the advertisement server 10 when determined by the user terminal that the above distance is greater than the upper threshold. Specifically, it may be configured not to execute Steps S109 and S113 of FIG. 21. The registration of association information may be prevented as a result in this manner.

In the above way, it becomes possible to prevent a user who is moving by a vehicle such as an automobile, for example, from registering an electronic coupon. If it is allowed to register an electronic coupon while moving by a vehicle such as an automobile, a huge number of electronic advertisements may be registered indiscriminatingly. Regarding this point, also with a configuration as this, occurrences of such an inconvenience can be prevented.

[7] For example, the control unit 11 may determine, based on the user's position at a first time point preceding the time point of the reception of the request to associate an electronic advertisement with a region in the real space and the user's position at a second time point preceding the first time point, whether or not the moving speed of the user is faster than a threshold. Further, the control unit 11 may reject the request for electronic coupon registration from this user when the above moving speed is faster than an upper threshold. In short, the control unit 11 may inhibit the registration of association information.

Note that the determination of whether or not the above moving speed is faster than the threshold may be executed on the user terminal 20. The result of the determination may then be transmitted to the advertisement server 10.

Alternatively, it maybe configured not to transmit the request to the advertisement server 10 when determined that the above moving speed is faster than the threshold on the user terminal 20. Specifically, it may be configured not to execute Steps S109 and S113 of FIG. 21. The registration of association information may be prevented as a result in this manner.

Even when it is configured as above, it is possible to prevent a user who is moving by a vehicle such as an automobile from registering an electronic coupon. If it is allowed to register an electronic coupon while moving by a vehicle such as an automobile, a huge number of electronic advertisements may be registered indiscriminatingly. Regarding this point, also with a configuration as this, occurrences of such an inconvenience can be prevented.

[8] The control unit 11 may determine whether or not the distance between the user's position at a first time point, which precedes the time point of the reception of a request to associate an electronic advertisement with a region in the real space, and the user's position at a second time point, which precedes the first time point, is less than a lower threshold. When the above distance is less than the lower threshold, the position/region setting unit 113 may set a position or a region to which the electronic coupon is to be registered based on at least one of the user's position at the first time point and the user's position at the second time point.

Note that the determination of whether or not the above distance is less than the lower threshold may be executed on the user terminal 20. The result of the determination may then be transmitted to the advertisement server 10.

Alternatively, it may be configured to transmit the user's position at the first time point and the user's position at the second time point to the advertisement server 10 only when determined that the above distance is less than the lower threshold. On the other hand, it may be configured not to transmit the user's position at the first time point and the user's position at the second time point to the advertisement server 10 when determined that the above distance is not less than the lower threshold on the user terminal 20.

The case where the distance between the user's position at the first time point and the user's position at the second time point is short is the case where the user has stayed in substantially the same place (e.g., at an intersection, a shop or the like) from the first time point to the second time point. In such places, other users are expected to stay as well. Therefore, in the above way, it becomes possible to present to the user a place where other users are likely to stay as a place to which electronic coupons can be registered.

[9] For example, the coupon list screen 90 displayed in the process of obtaining an electronic coupon may display not only an electronic coupon registered to the section 80 that includes the position of the user but also electronic coupons registered to the sections 80 that are close to this section 80.

In this case, the order in which electronic coupons are displayed may be set based on the distance between the section 80 to which an electronic coupon is registered and the position of the user. For example, the display order may be set so that an electronic coupon is placed higher in the display order, when a section 80 to which it is registered gets closer to the user's position. In other words, the place in display order of an electronic coupon registered to the section 80 that is at a short distance from the user's position may be set higher than the place in display order of an electronic coupon registered to the section 80 that is at a long distance from the user's position.

Alternatively, the display order of electronic coupons may be set based on the evaluation values of the electronic coupons.

In this case, the evaluation value of an electronic coupon is calculated based on the distance between the section 80 to which the electronic coupon is registered and the position of the user, and on the popularity of the electronic coupon. For example, the evaluation value is calculated so that a higher evaluation value is given when the above distance is shorter. Also, the evaluation value is calculated so that a higher evaluation value is given when the popularity is higher. Note that the popularity of an electronic coupon is set based on at least one of the number of times the electronic coupon is actually used and the number of users who have obtained the electronic coupon.

Alternatively, the coupon list screen 90 displayed in the process of obtaining an electronic coupon may display only electronic coupons that belong to a category specified by the user.

[10] For example, it is not necessary that the sections 80 has a uniform size. For example, the size of a section 80 may be varied depending on the population density of the area in which that section 80 is included. Specifically, it may be configured that the size of a section 80 is set relatively small in an area that is high in population density such as an inner city, whereas the size of a section 80 is set relatively large in an area that is low in population density such as a local area.

When the population density is high, for example, the probability that a plurality of users attempt to register the same electronic coupon to one section 80 gets high. As to this, the probability that a plurality of users attempt to register the same electronic coupon to one section 80 can be reduced by setting the size of a section 80 relatively small in an area that is high in population density.

In the case where the size of the sections 80 is varied in the manner described above, an interval at which position information is transmitted from the user terminal 20 to the advertisement server 10 may be controlled based on the size of a single section 80. Specifically, a position information transmission interval may be set larger as the size of a section 80 becomes larger, and set smaller as the size of a single section 80 becomes smaller.

When controlling a position information transmission interval based on the size of a section 80, association relation information becomes necessary which indicates an association relation between the position information transmission interval and the size of a section 80. This association relation information is set so that, as described above, the position information transmission interval is set larger as the size of a section 80 becomes larger, and set smaller as the size of a section 80 becomes smaller.

The above association relation information is stored in, for example, the storage unit 12 or the database 15, and the control unit 11 of the advertisement server 10 determines the above transmission interval in the user terminal 20 based on the association relation information described above and the position information of the user terminal 20. In this case, the control unit 11 of the advertisement server 10 notifies the determined transmission interval to the user terminal 20. The user terminal 20 executes position information transmission to the advertisement server 10 at the notified transmission interval.

Alternatively, the control unit 21 of the user terminal 20 may determine the above transmission interval in the user terminal 20 based on the association relation information and the position information of the user terminal 20. Note that in this case, the association relation information may be stored in the storage unit 22, or may be stored in the storage unit 12 or the database 15 to be supplied to the user terminal 20 via the communication network 2.

The frequency at which a section 80 that a user is currently located changes is low when the size of the section 80 is large. When the frequency at which a section 80 that a user is currently located changes is low, it becomes less necessary to transmit position information of the user terminal 20 to the advertisement server 10 at a high frequently. As to this point, in the above way, unnecessary transmission of position information can be prevented.

[11] For example, the candidate region 76 and the section 80 can have shapes other than rectangular shapes. However, keeping these regions as a rectangular shape can simplify processing.

[12] In the case where the user terminal 20 is provided with a sensor configured to detect the motion of the user terminal 20 (e.g., an acceleration sensor or a gyro sensor), for example, the operation of shaking the user terminal 20 may be employed as the operation of registering or obtaining an electronic coupon. For example, when the user shakes the user terminal 20 while designating any one of the section 80 on the section designating screen 70, it may be executed to associate an electronic coupon with the designated section 80. Similarly, an electronic coupon may be provided to the user on the coupon screen 100 when the user shakes the user terminal 20. Such a configuration causes users to shake their user terminals 20 on the street, which is expected to draw the attention of other people. An increase of the interest in services provided by the advertisement server 10 can be expected as a result.

[13] For example, the shop terminal 30 may display a screen for checking the registration status of an electronic coupon that is provided by the advertiser. In this case, it is only necessary to display this screen when the shop terminal 30 accesses the advertisement server 10.

[14] The advertisement system 1 may include a plurality of advertisement servers 10, for example. Processing (functions) may be divided among the plurality of advertisement servers 10 in this case. For instance, it may be configured that one advertisement server 10 executes processing that is related to the registration of an electronic coupon while another advertisement server 10 executes processing that is related to the providing of an electronic coupon. Specifically, the first position information obtaining unit 112, the position/region setting unit 113, and the association information registering unit 114 may be implemented by one advertisement server 10, while the second position information obtaining unit 115 and the electronic advertisement providing unit 116 are implemented by another advertisement server 10.

[15] For example, the first position information obtaining unit 112 may be implemented by the advertisement server 10.

Specifically, the user terminal 20 may transmit, to the advertisement server 10, information that is a basis for obtaining the position of the user terminal 20, instead of information that indicates the position itself of the user terminal 20.

For example, the user terminal 20 may transmit, to the advertisement server 10, information that indicates signals received by the GPS reception unit 24. Alternatively, the user terminal 20 may transmit position information of a cellular phone base station that is communicating with the user terminal 20 to the advertisement server 10. Still alternatively, the user terminal 20 may transmit, to the advertisement server 10, position information of a wireless LAN base station that is communicating with the user terminal 20. Based on the above information transmitted from the user terminal 20, the control unit 11 (the first position information obtaining unit 112) of the advertisement server 10 then obtains position information of the user terminal 20.

Note that the second position information obtaining unit 115 may be implemented by the advertisement server 10 as in the case of the first position information obtaining unit 112.

[16] For example, all or some of the storage unit 110, the position/region setting unit 113, the association information registering unit 114, and the electronic advertisement providing unit 116 may be implemented by the user terminal 20.

The user terminal 20 may implement, for example, function blocks other than the storage unit 110. In other words, the user terminal 20 (an advertisement processing device) maybe implemented so as to include function blocks other than the storage unit 110. Alternatively, the user terminal 20 (an advertisement processing device) may be implemented so as to include the first position information obtaining unit 112, the position/region setting unit 113, and the association information registering unit 114. Still alternatively, the user terminal 20 (an advertisement processing device) may be implemented so as to include the second position information obtaining unit 115 and the electronic advertisement providing unit 116.

Note that the estimation unit in Modification Example 2 may be implemented by the user terminal 20 as well.

[17] While the description given above deals mainly with cases of providing electronic coupons, the present invention can be applied to cases where electronic advertisements other than electronic coupons are provided as well. For instance, the present invention is also applicable to cases of providing electronic fliers. The present invention is also applicable to cases of providing image data (types of image data other than electronic coupons or electronic fliers) as an electronic advertisement. The present invention is further applicable to cases of providing audio data or animation data as an electronic advertisement.

### REFERENCE SIGNS LIST

1 advertisement system, 2 communication network, 10 advertisement server, 11, 21 control unit, 12, 22 storage unit, 13, 23 communication unit, 14 optical disc drive unit, 15 database, 20 user terminal, 24 GPS reception unit, 25 operation unit, 26 display unit, 27 audio output unit, 30 shop terminal, 40 menu screen, 42A, 42B, 42C menu button, 44 game point field, 46 shopping point field, 50, 90 coupon list screen, 52,92 coupon button, 54, 68, 78, 94, 108 back button, 60, 100 coupon screen, 62, 102 coupon, 64, 104 code image, 66 registration button, 70 section designating screen, 72 map, 74 user position, 76 candidate region, 80 section, 106 obtaining button, 110 storage unit, 111 association information storage unit, 112 first position information obtaining unit, 113 position/region setting unit, 114 association information registering unit, 115 second position information obtaining unit, 116 electronic advertisement providing unit, 120 substitute region, U1, U2 user, C electronic coupon, A region.

The invention claimed is:

1. An advertisement system, comprising:
at least one processor; and
at least one memory device that stores a plurality of instructions, which when executed by the at least one processor, cause the at least one processor to:
set, in a case where a request to associate an electronic advertisement with a region in real space is received from a user terminal, a position or a region with which the electronic advertisement is to be associated based on position information or region information, the position information being information that indicates a position of the user terminal and that has been obtained by the user terminal prior to the reception of the request, and the region information comprising the position information; and
register association information in a storage, the association information indicating an association between the electronic advertisement and the set position or the set region.

2. The advertisement system according to claim 1,
wherein the plurality of instructions cause the least one processor to execute at least one of:
setting a position or a region with which the electronic advertisement is to be associated based on a given multiple number of most recent pieces of position information that have been obtained by the user terminal prior to the reception of the request, or based on region information comprising at least one of the given multiple number of pieces of position information; and
setting a position or a region with which the electronic advertisement is to be associated based on a plurality of pieces of position information of a most recent given period that have been obtained by the user terminal prior to the reception of the request, or based on region information comprising at least one of the plurality of pieces of position information.

3. The advertisement system according to claim 1,
wherein the plurality of instructions cause the at least one processor to:
identify a region through which the user terminal has moved based on position information that has been obtained by the user terminal prior to the reception of the request, or based on region information comprising the position information; and
set for setting set the region through which the user terminal has moved as a region with which the electronic advertisement is to be associated.

4. The advertisement system according to claim 3,
wherein the plurality of instructions cause the at least one processor to:
identify a plurality of regions through which the user terminal has moved based on a plurality of pieces of position information that have been obtained by the user terminal prior to the reception of the request, or based on region information comprising at least one of the plurality of pieces of position information;
display the plurality of regions on the user terminal;
receive designation of at least one of the plurality of regions; and
set the designated region, as a region with which the electronic advertisement is to be associated.

5. The advertisement system according to claim 1,
wherein the plurality of instructions cause the at least one processor to set a past position of the user terminal as a position with which the electronic advertisement is to be associated, based on position information that has been obtained by the user terminal prior to the reception of the request.

6. The advertisement system according to claim 5,
wherein the plurality of instructions cause the at least one processor to:
display a plurality of past positions of the user terminal on the user terminal, based on a plurality of pieces of position information that have been obtained by the user terminal prior to the reception of the request;
receive a designation of at least one of the plurality of past positions; and
set the designated past position, as a position with which the electronic advertisement is to be associated.

7. The advertisement system according to claim 1,
wherein the plurality of instructions cause the at least one processor to:
estimate a current position of the user terminal, or a region where the user terminal is currently located, based on position information that has been obtained by the user terminal prior to the reception of the request, or based on region information comprising the position information; and
set a position or a region with which the electronic advertisement is to be associated, based on the estimated current position of the user terminal or the estimated region where the user terminal is currently located.

8. The advertisement system according to claim 1,
wherein the plurality of instructions cause the at least one processor to:
determine whether or not a distance between a position of the user terminal at a first time point and a position of the user terminal at a second time point is greater than an upper threshold, the first time point being a time point which precedes the reception of the request, and the second time point being a time point which precedes the first time point; and
inhibit a registration of the association information in a case where the distance is greater than the upper threshold.

9. The advertisement system according to claim 1,
wherein the plurality of instructions cause the at least one processor to:
determine whether or not a moving speed of the user terminal is faster than a threshold based on a position of the user terminal at a first time point and a position of the user terminal at a second time point, the first time point being a time point which precedes the reception of the request, and the second time point being a time point which precedes the first time point; and
inhibit a registration of the association information in a case where the moving speed of the user terminal is faster than the threshold.

10. The advertisement system according to claim 1,
wherein the plurality of instructions cause the at least one processor to:
determine whether or not a distance between a position of the user terminal at a first time point and a position of the user terminal at a second time point is less than a lower threshold, the first time point being a time point which precedes the reception of the request, and the second time point being a time point which precedes the first time point; and
set, in a case where the distance is less than the lower threshold, a position or a region with which the electronic advertisement is to be associated based on at least one of the position of the user terminal at the first time point and the position of the user terminal at the second time point.

11. An advertisement system control method, comprising:
setting, by the advertisement system, in a case where a request to associate an electronic advertisement with a region in real space is received from a user terminal, a position or a region with which the electronic advertisement is to be associated based on position information or region information, the position information being information that indicates a position of the user terminal and that has been obtained by the user terminal prior to the reception of the request, and the region information comprising the position information;
registering, by the advertisement system, association information in a storage, the association information indicating an association between the electronic advertisement and the set position or the set region.

12-13. (canceled)

14. A non-transitory information recording medium having a program recorded thereon, the program for causing a computer to:
set, in a case where a request to associate an electronic advertisement with a region in real space is received from a user terminal, a position or a region with which the electronic advertisement is to be associated based on position information or region information, the position information being information that indicates a position of the user terminal and that has been obtained by the user terminal prior to the reception of the request, and the region information comprising the position information; and
register association information in a storage, the association information indicating an association between the electronic advertisement and the set position or the set region.

15. The advertisement system according to claim 1,
wherein the plurality of instructions further cause the at least one processor to:
obtain an electronic advertisement to be provided to another user terminal from among electronic advertisements registered in the storage, based on position information that indicates a position of the other user terminal, and on positions or regions that are registered in the storage; and
display the obtained electronic advertisement on the other user terminal.
